(19) United States
(12) Patent Application Publication
(10) Pub. No.: US 2013/0135358 A1
(43) Pub. Date: May 30, 2013

(54) LIGHT COLLIMATING MANIFOLD FOR PRODUCING MULTIPLE VIRTUAL LIGHT SOURCES

(71) Applicants: Ye Yin, Santa Clara, CA (US); Russell Wayne Gruhlke, Milpitas, CA (US)

(72) Inventors: Ye Yin, Santa Clara, CA (US); Russell Wayne Gruhlke, Milpitas, CA (US)

(73) Assignee: QUALCOMM MEMS TECHNOLOGIES, INC., San Diego, CA (US)

(21) Appl. No.: 13/308,185

(22) Filed: Nov. 30, 2011

(51) Int. Cl. G09G 5/10; H01J 9/00; F21V 7/00; F21V 5/00; F21V 8/00

(52) U.S. Cl. 345/690; 362/327; 362/608; 362/602; 445/24

(57) ABSTRACT

The present disclosure provides systems, methods and apparatus to produce a plurality of virtual light sources and at least partially collimate light. In one aspect, a manifold to collimate light can produce a plurality of virtual light sources used to inject light into a light guide for illuminating a display. The manifold can be formed of optically transmissive material and can have a backside for receiving light from a light source and a front wall, opposite the backside, for outputting light. The front wall can include first and second output portions separated by a non-light emitting area, each of the output portions providing a separate virtual light source. The upper, bottom, and side walls of the manifold can extend along a curve from the backside to the front wall and can be configured to collimate light propagating in directions extending out of the plane of the light guide.

### CROSS-REFERENCE TO RELATED APPLICATIONS

This application is related to U.S. patent application Ser. No. 12/914,084, filed Oct. 28, 2010, titled “MANIFOLD FOR COLLIMATING LIGHT,” and assigned to the assignee hereof.

### TECHNICAL FIELD

This disclosure relates to light collimation and, more particularly, to a manifold and related methods for collimating light at virtual light sources.

### DESCRIPTION OF THE RELATED TECHNOLOGY

Electromechanical systems include devices having electrical and mechanical elements, actuators, transducers, sensors, optical components (e.g., mirrors) and electronics. Electromechanical systems can be manufactured at a variety of scales including, but not limited to, microscales and nanoscales. For example, microelectromechanical systems (MEMS) devices can include structures having sizes ranging from about a micron to hundreds of microns or more. Nanoelectromechanical systems (NEMS) devices can include structures having sizes smaller than a micron including, for example, sizes smaller than several hundred nanometers. Electromechanical elements may be created using deposition, etching, lithography, and/or other micromachining processes that etch away parts of substrates and/or deposited material layers, or that add layers to form electrical and electromechanical devices.

One type of electromechanical systems device is called an interferometric modulator (IMOD). As used herein, the term interferometric modulator or interferometric light modulator refers to a device that selectively absorbs and/or reflects light using the principles of optical interference. In some implementations, an interferometric modulator may include a pair of conductive plates, one or both of which may be transparent and/or reflective, wholly or in part, and capable of relative motion upon application of an appropriate electrical signal. In an implementation, one plate may include a stationary layer deposited on a substrate and the other plate may include a reflective membrane separated from the stationary layer by an air gap. The position of one plate in relation to another can change the optical interference of light incident on the interferometric modulator. Interferometric modulator devices have a wide range of applications, and are anticipated to be used in improving existing products and creating new products, especially those with display capabilities.

Reflected ambient light is used to form images in some display devices, such as reflective displays using pixels formed by interferometric modulators. The perceived brightness of these displays depends upon the amount of light that is reflected towards a viewer. In low ambient light conditions, light from an illumination device with an artificial light source is used to illuminate the reflective pixels, which then reflect the light towards a viewer to generate an image. To meet market demands and design criteria for display devices, including reflective and transmissive displays, new illumination devices are continually being developed.

### SUMMARY

The systems, methods and devices of the disclosure each have several innovative aspects, no single one of which is solely responsible for the desirable attributes disclosed herein.

One innovative aspect of the subject matter described in this disclosure can be implemented in a manifold system configured to produce virtual light sources. The manifold system includes an elongated manifold body of optically-transmissive material. The manifold body includes a backside configured to receive light from a light source. The manifold body further includes a front wall opposite the backside and configured to output light from the light source. The front wall includes first and second output portions separated by a non-light emitting area. The manifold body further includes a curved upper wall extending from the backside to the front wall, a curved lower wall extending from the backside to the front wall, a first curved side wall extending from the backside to the front wall, and a second curved side wall extending from the backside to the front wall. In an aspect, the body can be configured to output light in a plane defined by a first axis extending horizontally along a length of the front wall and a second axis extending from the backside to the front wall of the body. The light can have a relatively narrow angular distribution on axes out of the plane, relative to an angular distribution of light in the plane. In an aspect, the non-light emitting area can include a notch having at least two curved sides extending towards the backside. The notch can separate the first and second output portions of the front wall.

Another innovative aspect of the subject matter described in this disclosure can be implemented in a display device. The display device includes an array of display elements, a light source, and a light guide. The light guide has light turning features configured to redirect light generated by the light source towards the array of display elements. The display device further includes a virtual light generating means for generating a plurality of virtual light sources from the light source. The virtual light generating means can be configured to collimate light generated by the light source and output the collimated light in a plane defined by a first axis extending horizontally along a length of the front wall and a second axis extending from the backside to the front wall of the body. The light can have a relatively narrow angular distribution on axes out of the plane, relative to an angular distribution of light in the plane. The virtual light generating means can be positioned to output the collimated light into the light guide.

Another innovative aspect of the subject matter described in this disclosure can be implemented in a method of manufacturing a display device. The method includes providing a light guide panel, providing a light source, and providing a light collimating manifold between the light source and the light guide panel. The light collimating manifold is configured to output light from first and second output portions separated by a non-light emitting area. In an aspect, the light collimating manifold can be configured to output light from the light source in a relatively narrow angular distribution out of a plane of the light guide panel, relative to an angular distribution of light in the plane of the light guide panel.

Details of one or more implementations of the subject matter described in this specification are set forth in the accompanying drawings and the description below. Other features, aspects, and advantages will become apparent from the description, the drawings, and the claims. Note that the relative dimensions of the following figures may not be drawn to scale.

### BRIEF DESCRIPTION OF THE DRAWINGS

FIG. 1 shows an example of an isometric view depicting two adjacent pixels in a series of pixels of an interferometric modulator (IMOD) display device.

FIG. 2 shows an example of a system block diagram illustrating an electronic device incorporating a 3×3 interferometric modulator display.

FIG. 3 shows an example of a diagram illustrating movable reflective layer position versus applied voltage for the interferometric modulator of FIG. 1.

FIG. 4 shows an example of a table illustrating various states of an interferometric modulator when various common and segment voltages are applied.

FIG. 5A shows an example of a diagram illustrating a frame of display data in the 3×3 interferometric modulator display of FIG. 2.

FIG. 5B shows an example of a timing diagram for common and segment signals that may be used to write the frame of display data illustrated in FIG. 5A.

FIG. 6A shows an example of a partial cross-section of the interferometric modulator display of FIG. 1.

FIGS. 6B-6E show examples of cross-sections of varying implementations of interferometric modulators.

FIG. 7 shows an example of a flow diagram illustrating a manufacturing process for an interferometric modulator.

FIGS. 8A-8E show examples of cross-sectional schematic illustrations of various stages in a method of making an interferometric modulator.

FIG. 9A shows an example of a cross section of a display system that includes a front light.

FIG. 9B shows an example of a top-down view of the display system in FIG. 9A.

FIG. 10 shows an example of a cross section of a display system with a light manifold.

FIG. 11 shows an example of a top-down view of the display system in FIG. 10.

FIGS. 12A-12D show examples of, respectively, side, top-down, perspective and front views of a manifold.

FIG. 13 shows an example of a cross-sectional side view of a manifold.

FIG. 14 illustrates an example of a Bezier curve.

FIG. 15 shows an example of another cross-sectional side view of a manifold.

FIG. 16 illustrates an example of a graph showing the curve of a manifold sidewall.

FIG. 17 shows another example of a cross sectional side view of a manifold.

FIG. 18 is an example of a method for manufacturing a display system.

FIGS. 19A and 19B show examples of system block diagrams illustrating a display device that includes a plurality of interferometric modulators.

Like reference numbers and designations in the various drawings indicate like elements.

### DETAILED DESCRIPTION

The following detailed description is directed to certain implementations for the purposes of describing the innovative aspects. However, the teachings herein can be applied in a multitude of different ways. The described implementations may be implemented in any device that is configured to display an image, whether in motion (e.g., video) or stationary (e.g., still image), and whether textual, graphical or pictorial. More particularly, it is contemplated that the implementations may be implemented in or associated with a variety of electronic devices such as, but not limited to, mobile telephones, multimedia Internet enabled cellular telephones, mobile television receivers, wireless devices, smartphones, Bluetooth® devices, personal data assistants (PDAs), wireless electronic mail receivers, hand-held or portable computers, netbooks, notebooks, smartbooks, tablets, printers, copiers, scanners, facsimile devices, GPS receivers/navigators, cameras, MP3 players, camcorders, game consoles, wrist watches, clocks, calculators, television monitors, flat panel displays, electronic reading devices (e.g., e-readers), computer monitors, auto displays (e.g., odometer display, etc.), cockpit controls and/or displays, camera view displays (e.g., display of a rear view camera in a vehicle), electronic photographs, electronic billboards or signs, projectors, architectural structures, microwaves, refrigerators, stereo systems, cassette recorders or players, DVD players, CD players, VCRs, radios, portable memory chips, washers, dryers, washer/dryers, parking meters, packaging (e.g., MEMS and non-MEMS), aesthetic structures (e.g., display of images on a piece of jewelry) and a variety of electromechanical systems devices. The teachings herein also can be used in non-display applications such as, but not limited to, electronic switching devices, radio frequency filters, sensors, accelerometers, gyroscopes, motion-sensing devices, magnetometers, inertial components for consumer electronics, parts of consumer electronics products, varactors, liquid crystal devices, electrophoretic devices, drive schemes, manufacturing processes, and electronic test equipment. Thus, the teachings are not intended to be limited to the implementations depicted solely in the Figures, but instead have wide applicability as will be readily apparent to a person having ordinary skill in the art.

In some implementations, a manifold is provided to produce a plurality of virtual light sources, and to at least partially collimate light. For example, the manifold can accept light from a single light source and output the light such that the light appears to be emitted from two distinct, spaced-apart light sources, which are referred to herein as virtual light sources. The virtual light sources are “virtual” in the sense that there is not a physical light source at the location that light appears to be emitted from; rather the apparent position of the virtual light sources is due to the optics of the manifold. In some implementations, the manifold may be disposed between a light source and a light guide panel. In some implementations, the light source generates light, which passes into and is at least partially collimated by the manifold. The manifold has a plurality of output portions separated by a non-light emitting area and each output portion can provide a virtual light source. The outputted light may be injected into the light guide panel, which turns the light towards the pixels of the display, in some implementations.

In addition to providing virtual light sources, the manifold can be configured to collimate light that would otherwise propagate in directions extending out of the plane of the light guide panel. The collimated light can propagate in a relatively narrow range of directions and can travel more parallel to the plane of the light guide panel, where the plane is defined by the length and width of the light guide (as seen in top down view). Conversely, uncollimated or less collimated light can propagate in the plane of the light guide panel in a relatively wide range of directions. In some implementations, the manifold is configured to output light in a plane defined by a first axis extending horizontally along a length of the front wall of the manifold and a second axis extending from a backside of the manifold to the front wall of the manifold. The outputted light has a relatively narrow angular distribution on axes out of the plane and a relatively wide angular distribution in the above-noted plane, which may correspond to the plane of the light guide panel.

The manifold can be formed of optically transmissive material with the backside of the manifold configured for receiving light from a light source and the front wall for outputting the light. The front wall is disposed opposite the backside, is divided into a plurality of output portions separated by a non-light emitting area, and can include a plurality of lens. The upper, lower, and side walls of the manifold can extend along curves from the backside to the front wall. The curve may be a Bezier curve. The front wall may have for example, a generally rectangular shape, with the upper and lower walls defining the long dimensions of the rectangle, and sidewalls of the manifold defining the short dimensions of the rectangle. The front wall may include a non-light emitting area. In some implementations, the manifold may be hollowed, with an internal cavity that opens to the backside.

Particular implementations of the subject matter described in this disclosure can be implemented to realize one or more of the following potential advantages. For example, illumination from multiple virtual light sources can reduce the number of conventional light sources used to provide a display with substantially uniform perceived brightness. Accordingly, manufacturing costs may be reduced, due to the reduction in the number of light sources used. In addition, an increased number of light sources can reduce the visibility of display artifacts such as, for example, cross-hatch artifacts. Moreover, virtual light sources may be spaced closer to each other than may otherwise be possible, given the relatively large sizes of conventional light sources. This can reduce optical artifacts caused by relatively widely spaced light sources. As another example, the collimation of out-of-plane light from a light source can increase the perceived brightness of a display device when using the manifold with the light source. Light that would otherwise propagate out of the plane of a light guide can be collimated so that it instead propagates by total internal reflection inside the light guide, thereby allowing that light to be used to illuminate the display, rather than escaping out of the light guide. However, light already propagating in the plane of the light guide may not be collimated, so that it propagates in a wide range of angles, thereby giving a highly uniform distribution of light over the area of the light guide. This uniformity can provide a display with a highly uniform perceived brightness.

An example of a suitable MEMS device, to which the described implementations may apply, is a reflective display device. Reflective display devices can incorporate interferometric modulators (IMODs) to selectively absorb and/or reflect light incident thereon using principles of optical interference. IMODs can include an absorber, a reflector that is movable with respect to the absorber, and an optical resonant cavity defined between the absorber and the reflector. The reflector can be moved to two or more different positions, which can change the size of the optical resonant cavity and thereby affect the reflectance of the interferometric modulator. The reflectance spectrums of IMODs can create fairly broad spectral bands which can be shifted across the visible wavelengths to generate different colors. The position of the spectral band can be adjusted by changing the thickness of the optical resonant cavity, i.e., by changing the position of the reflector.

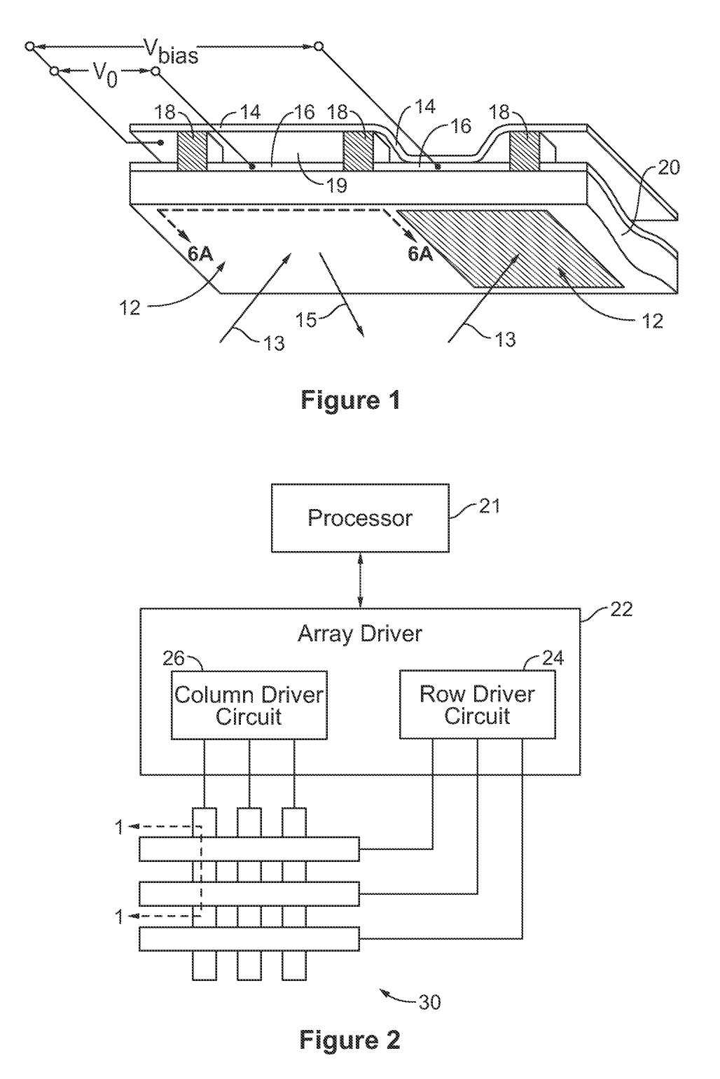

FIG. 1 shows an example of an isometric view depicting two adjacent pixels in a series of pixels of an interferometric modulator (IMOD) display device. The IMOD display device includes one or more interferometric MEMS display elements. In these devices, the pixels of the MEMS display elements can be in either a bright or dark state. In the bright (“relaxed,” “open” or “on”) state, the display element reflects a large portion of incident visible light, e.g., to a user. Conversely, in the dark (“actuated,” “closed” or “off”) state, the display element reflects little incident visible light. In some implementations, the light reflectance properties of the on and off states may be reversed. MEMS pixels can be configured to reflect predominantly at particular wavelengths allowing for a color display in addition to black and white.

The IMOD display device can include a row/column array of IMODs. Each IMOD can include a pair of reflective layers, i.e., a movable reflective layer and a fixed partially reflective layer, positioned at a variable and controllable distance from each other to form an air gap (also referred to as an optical gap or cavity). The movable reflective layer may be moved between at least two positions. In a first position, i.e., a relaxed position, the movable reflective layer can be positioned at a relatively large distance from the fixed partially reflective layer. In a second position, i.e., an actuated position, the movable reflective layer can be positioned more closely to the partially reflective layer. Incident light that reflects from the two layers can interfere constructively or destructively depending on the position of the movable reflective layer, producing either an overall reflective or non-reflective state for each pixel. In some implementations, the IMOD may be in a reflective state when unactuated, reflecting light within the visible spectrum, and may be in a dark state when actuated, reflecting light outside of the visible range (e.g., infrared light). In some other implementations, however, an IMOD may be in a dark state when unactuated, and in a reflective state when actuated. In some implementations, the introduction of an applied voltage can drive the pixels to change states. In some other implementations, an applied charge can drive the pixels to change states.

The depicted portion of the pixel array in FIG. 1 includes two adjacent interferometric modulators 12. In the IMOD 12 on the left (as illustrated), a movable reflective layer 14 is illustrated in a relaxed position at a predetermined distance from an optical stack 16, which includes a partially reflective layer. The voltage V₀ applied across the IMOD 12 on the left is insufficient to cause actuation of the movable reflective layer 14. In the IMOD 12 on the right, the movable reflective layer 14 is illustrated in an actuated position near or adjacent the optical stack 16. The voltage V_{bias} applied across the IMOD 12 on the right is sufficient to maintain the movable reflective layer 14 in the actuated position.

In FIG. 1, the reflective properties of pixels 12 are generally illustrated with arrows indicating light 13 incident upon the pixels 12, and light 15 reflecting from the pixel 12 on the left. Although not illustrated in detail, it will be understood by a person having ordinary skill in the art that most of the light 13 incident upon the pixels 12 will be transmitted through the transparent substrate 20, toward the optical stack 16. A portion of the light incident upon the optical stack 16 will be transmitted through the partially reflective layer of the optical stack 16, and a portion will be reflected back through the transparent substrate 20. The portion of light 13 that is transmitted through the optical stack 16 will be reflected at the movable reflective layer 14, back toward (and through) the transparent substrate 20. Interference (constructive or destructive) between the light reflected from the partially reflective layer of the optical stack 16 and the light reflected from the movable reflective layer 14 will determine the wavelength(s) of light 15 reflected from the pixel 12.

The optical stack 16 can include a single layer or several layers. The layer(s) can include one or more of an electrode layer, a partially reflective and partially transmissive layer and a transparent dielectric layer. In some implementations, the optical stack 16 is electrically conductive, partially transparent and partially reflective, and may be fabricated, for example, by depositing one or more of the above layers onto a transparent substrate 20. The electrode layer can be formed from a variety of materials, such as various metals, for example indium tin oxide (ITO). The partially reflective layer can be formed from a variety of materials that are partially reflective, such as various metals, e.g., chromium (Cr), semiconductors, and dielectrics. The partially reflective layer can be formed of one or more layers of materials, and each of the layers can be formed of a single material or a combination of materials. In some implementations, the optical stack 16 can include a single semi-transparent thickness of metal or semiconductor which serves as both an optical absorber and conductor, while different, more conductive layers or portions (e.g., of the optical stack 16 or of other structures of the IMOD) can serve to bus signals between IMOD pixels. The optical stack 16 also can include one or more insulating or dielectric layers covering one or more conductive layers or a conductive/absorptive layer.

In some implementations, the layer(s) of the optical stack 16 can be patterned into parallel strips, and may form row electrodes in a display device as described further below. As will be understood by one having skill in the art, the term “patterned” is used herein to refer to masking as well as etching processes. In some implementations, a highly conductive and reflective material, such as aluminum (Al), may be used for the movable reflective layer 14, and these strips may form column electrodes in a display device. The movable reflective layer 14 may be formed as a series of parallel strips of a deposited metal layer or layers (orthogonal to the row electrodes of the optical stack 16) to form columns deposited on top of posts 18 and an intervening sacrificial material deposited between the posts 18. When the sacrificial material is etched away, a defined gap 19, or optical cavity, can be formed between the movable reflective layer 14 and the optical stack 16. In some implementations, the spacing between posts 18 may be approximately 1-1000 um, while the gap 19 may be less than 10,000 Angstroms (Å).

In some implementations, each pixel of the IMOD, whether in the actuated or relaxed state, is essentially a capacitor formed by the fixed and moving reflective layers. When no voltage is applied, the movable reflective layer 14 remains in a mechanically relaxed state, as illustrated by the pixel 12 on the left in FIG. 1, with the gap 19 between the movable reflective layer 14 and optical stack 16. However, when a potential difference, e.g., voltage, is applied to at least one of a selected row and column, the capacitor formed at the intersection of the row and column electrodes at the corresponding pixel becomes charged, and electrostatic forces pull the electrodes together. If the applied voltage exceeds a threshold, the movable reflective layer 14 can deform and move near or against the optical stack 16. A dielectric layer (not shown) within the optical stack 16 may prevent shorting and control the separation distance between the layers 14 and 16, as illustrated by the actuated pixel 12 on the right in FIG. 1. The behavior is the same regardless of the polarity of the applied potential difference. Though a series of pixels in an array may be referred to in some instances as “rows” or “columns,” a person having ordinary skill in the art will readily understand that referring to one direction as a “row” and another as a “column” is arbitrary. Restated, in some orientations, the rows can be considered columns, and the columns considered to be rows. Furthermore, the display elements may be evenly arranged in orthogonal rows and columns (an “array”), or arranged in non-linear configurations, for example, having certain positional offsets with respect to one another (a “mosaic”). The terms “array” and “mosaic” may refer to either configuration. Thus, although the display is referred to as including an “array” or “mosaic,” the elements themselves need not be arranged orthogonally to one another, or disposed in an even distribution, in any instance, but may include arrangements having asymmetric shapes and unevenly distributed elements.

FIG. 2 shows an example of a system block diagram illustrating an electronic device incorporating a 3×3 interferometric modulator display. The electronic device includes a processor 21 that may be configured to execute one or more software modules. In addition to executing an operating system, the processor 21 may be configured to execute one or more software applications, including a web browser, a telephone application, an email program, or any other software application.

The processor 21 can be configured to communicate with an array driver 22. The array driver 22 can include a row driver circuit 24 and a column driver circuit 26 that provide signals to, e.g., a display array or panel 30. The cross section of the IMOD display device illustrated in FIG. 1 is shown by the lines 1-1 in FIG. 2. Although FIG. 2 illustrates a 3×3 array of IMODs for the sake of clarity, the display array 30 may contain a very large number of IMODs, and may have a different number of IMODs in rows than in columns, and vice versa.

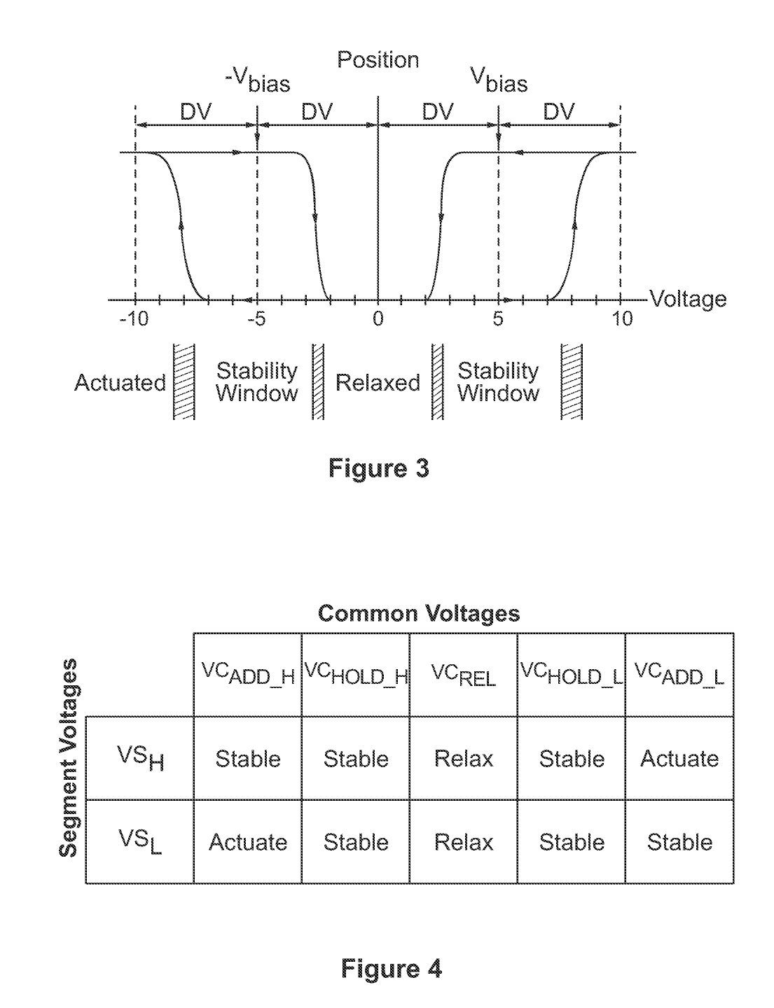

FIG. 3 shows an example of a diagram illustrating movable reflective layer position versus applied voltage for the interferometric modulator of FIG. 1. For MEMS interferometric modulators, the row/column (i.e., common/segment) write procedure may take advantage of a hysteresis property of these devices as illustrated in FIG. 3. An interferometric modulator may require, for example, about a 10-volt potential difference to cause the movable reflective layer, or mirror, to change from the relaxed state to the actuated state. When the voltage is reduced from that value, the movable reflective layer maintains its state as the voltage drops back below, e.g., 10-volts, however, the movable reflective layer does not relax completely until the voltage drops below 2-volts. Thus, a range of voltage, approximately 3 to 7-volts, as shown in FIG. 3, exists where there is a window of applied voltage within which the device is stable in either the relaxed or actuated state. This is referred to herein as the “hysteresis window” or “stability window.” For a display array 30 having the hysteresis characteristics of FIG. 3, the row/column write procedure can be designed to address one or more rows at a time, such that during the addressing of a given row, pixels in the addressed row that are to be actuated are exposed to a voltage difference of about 10-volts, and pixels that are to be relaxed are exposed to a voltage difference of near zero volts. After addressing, the pixels are exposed to a steady state or bias voltage difference of approximately 5-volts such that they remain in the previous strobing state. In this example, after being addressed, each pixel sees a potential difference within the “stability window” of about 3-7-volts. This hysteresis property feature enables the pixel design, e.g., illustrated in FIG. 1, to remain stable in either an actuated or relaxed pre-existing state under the same applied voltage conditions. Since each IMOD pixel, whether in the actuated or relaxed state, is essentially a capacitor formed by the fixed and moving reflective layers, this stable state can be held at a steady voltage within the hysteresis window without substantially consuming or losing power. Moreover, essentially little or no current flows into the IMOD pixel if the applied voltage potential remains substantially fixed.

In some implementations, a frame of an image may be created by applying data signals in the form of “segment” voltages along the set of column electrodes, in accordance with the desired change (if any) to the state of the pixels in a given row. Each row of the array can be addressed in turn, such that the frame is written one row at a time. To write the desired data to the pixels in a first row, segment voltages corresponding to the desired state of the pixels in the first row can be applied on the column electrodes, and a first row pulse in the form of a specific “common” voltage or signal can be applied to the first row electrode. The set of segment voltages can then be changed to correspond to the desired change (if any) to the state of the pixels in the second row, and a second common voltage can be applied to the second row electrode. In some implementations, the pixels in the first row are unaffected by the change in the segment voltages applied along the column electrodes, and remain in the state they were set to during the first common voltage row pulse. This process may be repeated for the entire series of rows, or alternatively, columns, in a sequential fashion to produce the image frame. The frames can be refreshed and/or updated with new image data by continually repeating this process at some desired number of frames per second.

The combination of segment and common signals applied across each pixel (that is, the potential difference across each pixel) determines the resulting state of each pixel. FIG. 4 shows an example of a table illustrating various states of an interferometric modulator when various common and segment voltages are applied. As will be readily understood by one having ordinary skill in the art, the “segment” voltages can be applied to either the column electrodes or the row electrodes, and the “common” voltages can be applied to the other of the column electrodes or the row electrodes.

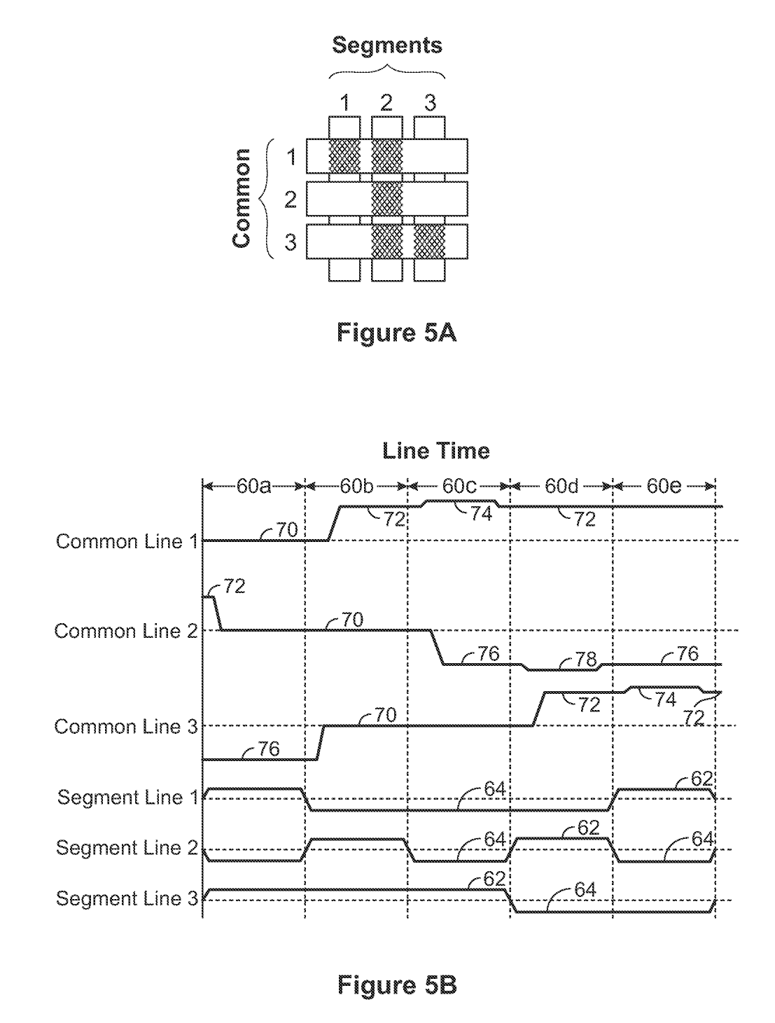

As illustrated in FIG. 4 (as well as in the timing diagram shown in FIG. 5B), when a release voltage VC_{REL} is applied along a common line, all interferometric modulator elements along the common line will be placed in a relaxed state, alternatively referred to as a released or unactuated state, regardless of the voltage applied along the segment lines, i.e., high segment voltage VS_{H} and low segment voltage VS_{L}. In particular, when the release voltage VC_{REL} is applied along a common line, the potential voltage across the modulator (alternatively referred to as a pixel voltage) is within the relaxation window (see FIG. 3, also referred to as a release window) both when the high segment voltage VS_{H} and the low segment voltage VS_{L} are applied along the corresponding segment line for that pixel.

When a hold voltage is applied on a common line, such as a high hold voltage VC_{HOLD}_{_{—}}_{H} or a low hold voltage VC_{HOLD}_{_{—}}_{L}, the state of the interferometric modulator will remain constant. For example, a relaxed IMOD will remain in a relaxed position, and an actuated IMOD will remain in an actuated position. The hold voltages can be selected such that the pixel voltage will remain within a stability window both when the high segment voltage VS_{H} and the low segment voltage VS_{L} are applied along the corresponding segment line. Thus, the segment voltage swing, i.e., the difference between the high VS_{H} and low segment voltage VS_{L}, is less than the width of either the positive or the negative stability window.

When an addressing, or actuation, voltage is applied on a common line, such as a high addressing voltage VC_{ADD}_{_{—}}_{H} or a low addressing voltage VC_{ADD}_{_{—}}_{L}, data can be selectively written to the modulators along that line by application of segment voltages along the respective segment lines. The segment voltages may be selected such that actuation is dependent upon the segment voltage applied. When an addressing voltage is applied along a common line, application of one segment voltage will result in a pixel voltage within a stability window, causing the pixel to remain unactuated. In contrast, application of the other segment voltage will result in a pixel voltage beyond the stability window, resulting in actuation of the pixel. The particular segment voltage which causes actuation can vary depending upon which addressing voltage is used. In some implementations, when the high addressing voltage VC_{ADD}_{_{—}}_{H} is applied along the common line, application of the high segment voltage VS_{H} can cause a modulator to remain in its current position, while application of the low segment voltage VS_{L} can cause actuation of the modulator. As a corollary, the effect of the segment voltages can be the opposite when a low addressing voltage VC_{ADD}_{_{—}}_{L} is applied, with high segment voltage VS_{H} causing actuation of the modulator, and low segment voltage VS_{L} having no effect (i.e., remaining stable) on the state of the modulator.

In some implementations, hold voltages, address voltages, and segment voltages may be used which always produce the same polarity potential difference across the modulators. In some other implementations, signals can be used which alternate the polarity of the potential difference of the modulators. Alternation of the polarity across the modulators (that is, alternation of the polarity of write procedures) may reduce or inhibit charge accumulation which could occur after repeated write operations of a single polarity.

FIG. 5A shows an example of a diagram illustrating a frame of display data in the 3×3 interferometric modulator display of FIG. 2. FIG. 5B shows an example of a timing diagram for common and segment signals that may be used to write the frame of display data illustrated in FIG. 5A. The signals can be applied to the, e.g., 3×3 array of FIG. 2, which will ultimately result in the line time 60e display arrangement illustrated in FIG. 5A. The actuated modulators in FIG. 5A are in a dark-state, i.e., where a substantial portion of the reflected light is outside of the visible spectrum so as to result in a dark appearance to, e.g., a viewer. Prior to writing the frame illustrated in FIG. 5A, the pixels can be in any state, but the write procedure illustrated in the timing diagram of FIG. 5B presumes that each modulator has been released and resides in an unactuated state before the first line time 60a.

During the first line time 60a: a release voltage 70 is applied on common line 1; the voltage applied on common line 2 begins at a high hold voltage 72 and moves to a release voltage 70; and a low hold voltage 76 is applied along common line 3. Thus, the modulators (common 1, segment 1), (1,2) and (1,3) along common line 1 remain in a relaxed, or unactuated, state for the duration of the first line time 60a, the modulators (2,1), (2,2) and (2,3) along common line 2 will move to a relaxed state, and the modulators (3,1), (3,2) and (3,3) along common line 3 will remain in their previous state. With reference to FIG. 4, the segment voltages applied along segment lines 1, 2 and 3 will have no effect on the state of the interferometric modulators, as none of common lines 1, 2 or 3 are being exposed to voltage levels causing actuation during line time 60a (i.e., VC_{REL}—relax and VC_{HOLD}_{_{—}}_{L}—stable).

During the second line time 60b, the voltage on common line 1 moves to a high hold voltage 72, and all modulators along common line 1 remain in a relaxed state regardless of the segment voltage applied because no addressing, or actuation, voltage was applied on the common line 1. The modulators along common line 2 remain in a relaxed state due to the application of the release voltage 70, and the modulators (3,1), (3,2) and (3,3) along common line 3 will relax when the voltage along common line 3 moves to a release voltage 70.

During the third line time 60c, common line 1 is addressed by applying a high address voltage 74 on common line 1. Because a low segment voltage 64 is applied along segment lines 1 and 2 during the application of this address voltage, the pixel voltage across modulators (1,1) and (1,2) is greater than the high end of the positive stability window (i.e., the voltage differential exceeded a predefined threshold) of the modulators, and the modulators (1,1) and (1,2) are actuated. Conversely, because a high segment voltage 62 is applied along segment line 3, the pixel voltage across modulator (1,3) is less than that of modulators (1,1) and (1,2), and remains within the positive stability window of the modulator; modulator (1,3) thus remains relaxed. Also during line time 60c, the voltage along common line 2 decreases to a low hold voltage 76, and the voltage along common line 3 remains at a release voltage 70, leaving the modulators along common lines 2 and 3 in a relaxed position.

During the fourth line time 60d, the voltage on common line 1 returns to a high hold voltage 72, leaving the modulators along common line 1 in their respective addressed states. The voltage on common line 2 is decreased to a low address voltage 78. Because a high segment voltage 62 is applied along segment line 2, the pixel voltage across modulator (2,2) is below the lower end of the negative stability window of the modulator, causing the modulator (2,2) to actuate. Conversely, because a low segment voltage 64 is applied along segment lines 1 and 3, the modulators (2,1) and (2,3) remain in a relaxed position. The voltage on common line 3 increases to a high hold voltage 72, leaving the modulators along common line 3 in a relaxed state.

Finally, during the fifth line time 60e, the voltage on common line 1 remains at high hold voltage 72, and the voltage on common line 2 remains at a low hold voltage 76, leaving the modulators along common lines 1 and 2 in their respective addressed states. The voltage on common line 3 increases to a high address voltage 74 to address the modulators along common line 3. As a low segment voltage 64 is applied on segment lines 2 and 3, the modulators (3,2) and (3,3) actuate, while the high segment voltage 62 applied along segment line 1 causes modulator (3,1) to remain in a relaxed position. Thus, at the end of the fifth line time 60e, the 3×3 pixel array is in the state shown in FIG. 5A, and will remain in that state as long as the hold voltages are applied along the common lines, regardless of variations in the segment voltage which may occur when modulators along other common lines (not shown) are being addressed.

In the timing diagram of FIG. 5B, a given write procedure (i.e., line times 60a-60e) can include the use of either high hold and address voltages, or low hold and address voltages. Once the write procedure has been completed for a given common line (and the common voltage is set to the hold voltage having the same polarity as the actuation voltage), the pixel voltage remains within a given stability window, and does not pass through the relaxation window until a release voltage is applied on that common line. Furthermore, as each modulator is released as part of the write procedure prior to addressing the modulator, the actuation time of a modulator, rather than the release time, may determine the necessary line time. Specifically, in implementations in which the release time of a modulator is greater than the actuation time, the release voltage may be applied for longer than a single line time, as depicted in FIG. 5B. In some other implementations, voltages applied along common lines or segment lines may vary to account for variations in the actuation and release voltages of different modulators, such as modulators of different colors.

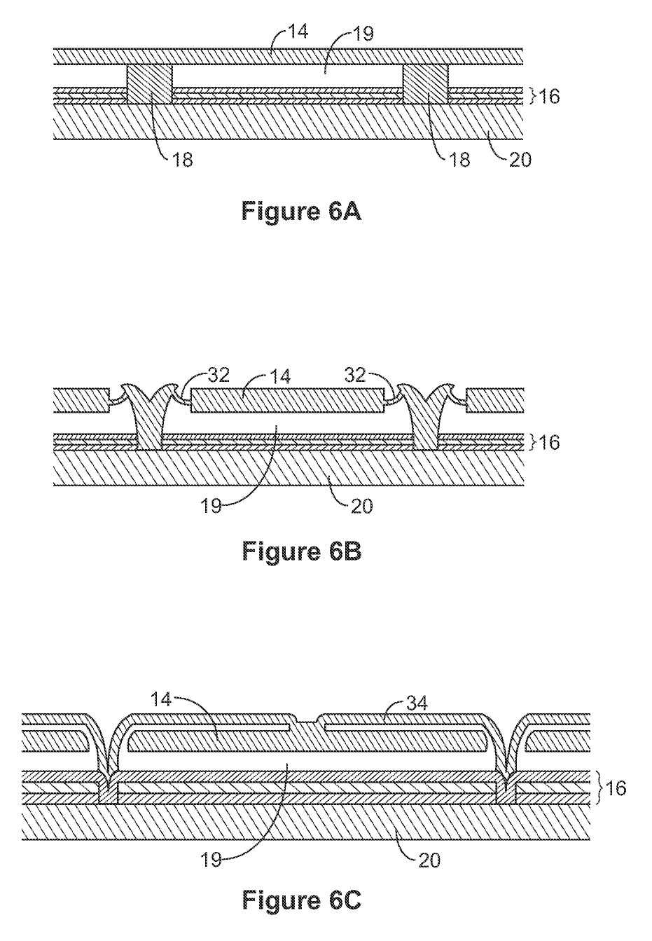

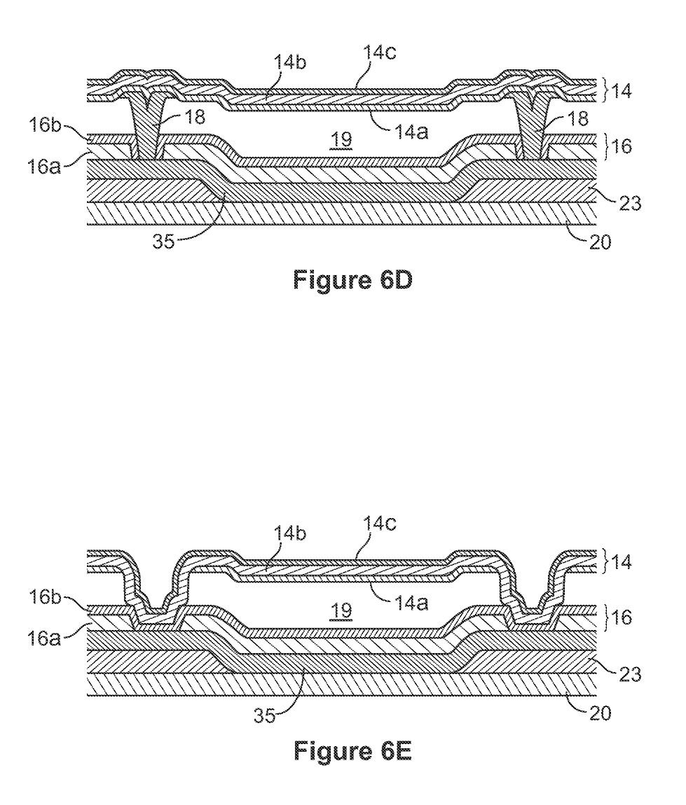

The details of the structure of interferometric modulators that operate in accordance with the principles set forth above may vary widely. For example, FIGS. 6A-6E show examples of cross-sections of varying implementations of interferometric modulators, including the movable reflective layer 14 and its supporting structures. FIG. 6A shows an example of a partial cross-section of the interferometric modulator display of FIG. 1, where a strip of metal material, i.e., the movable reflective layer 14 is deposited on supports 18 extending orthogonally from the substrate 20. In FIG. 6B, the movable reflective layer 14 of each IMOD is generally square or rectangular in shape and attached to supports at or near the corners, on tethers 32. In FIG. 6C, the movable reflective layer 14 is generally square or rectangular in shape and suspended from a deformable layer 34, which may include a flexible metal. The deformable layer 34 can connect, directly or indirectly, to the substrate 20 around the perimeter of the movable reflective layer 14. These connections are herein referred to as support posts. The implementation shown in FIG. 6C has additional benefits deriving from the decoupling of the optical functions of the movable reflective layer 14 from its mechanical functions, which are carried out by the deformable layer 34. This decoupling allows the structural design and materials used for the reflective layer 14 and those used for the deformable layer 34 to be optimized independently of one another.

FIG. 6D shows another example of an IMOD, where the movable reflective layer 14 includes a reflective sub-layer 14a. The movable reflective layer 14 rests on a support structure, such as support posts 18. The support posts 18 provide separation of the movable reflective layer 14 from the lower stationary electrode (i.e., part of the optical stack 16 in the illustrated IMOD) so that a gap 19 is formed between the movable reflective layer 14 and the optical stack 16, for example when the movable reflective layer 14 is in a relaxed position. The movable reflective layer 14 also can include a conductive layer 14c, which may be configured to serve as an electrode, and a support layer 14b. In this example, the conductive layer 14c is disposed on one side of the support layer 14b, distal from the substrate 20, and the reflective sub-layer 14a is disposed on the other side of the support layer 14b, proximal to the substrate 20. In some implementations, the reflective sub-layer 14a can be conductive and can be disposed between the support layer 14b and the optical stack 16. The support layer 14b can include one or more layers of a dielectric material, for example, silicon oxynitride (SiON) or silicon dioxide (SiO₂). In some implementations, the support layer 14b can be a stack of layers, such as, for example, a SiO₂/SiON/SiO₂ tri-layer stack. Either or both of the reflective sub-layer 14a and the conductive layer 14c can include, e.g., an aluminum (Al) alloy with about 0.5% copper (Cu), or another reflective metallic material. Employing conductive layers 14a, 14c above and below the dielectric support layer 14b can balance stresses and provide enhanced conduction. In some implementations, the reflective sub-layer 14a and the conductive layer 14c can be formed of different materials for a variety of design purposes, such as achieving specific stress profiles within the movable reflective layer 14.

As illustrated in FIG. 6D, some implementations also can include a black mask structure 23. The black mask structure 23 can be formed in optically inactive regions (e.g., between pixels or under posts 18) to absorb ambient or stray light. The black mask structure 23 also can improve the optical properties of a display device by inhibiting light from being reflected from or transmitted through inactive portions of the display, thereby increasing the contrast ratio. Additionally, the black mask structure 23 can be conductive and be configured to function as an electrical bussing layer. In some implementations, the row electrodes can be connected to the black mask structure 23 to reduce the resistance of the connected row electrode. The black mask structure 23 can be formed using a variety of methods, including deposition and patterning techniques. The black mask structure 23 can include one or more layers. For example, in some implementations, the black mask structure 23 includes a molybdenum-chromium (MoCr) layer that serves as an optical absorber, a layer, and an aluminum alloy that serves as a reflector and a bussing layer, with a thickness in the range of about 30-80 Å, 500-1000 Å, and 500-6000 Å, respectively. The one or more layers can be patterned using a variety of techniques, including photolithography and dry etching, including, for example, carbon tetrafluoride (CF₄) and/or oxygen (O₂) for the MoCr and SiO₂ layers and chlorine (Cl₂) and/or boron trichloride (BCl₃) for the aluminum alloy layer. In some implementations, the black mask 23 can be an etalon or interferometric stack structure. In such interferometric stack black mask structures 23, the conductive absorbers can be used to transmit or bus signals between lower, stationary electrodes in the optical stack 16 of each row or column. In some implementations, a spacer layer 35 can serve to generally electrically isolate the absorber layer 16a from the conductive layers in the black mask 23.

FIG. 6E shows another example of an IMOD, where the movable reflective layer 14 is self supporting. In contrast with FIG. 6D, the implementation of FIG. 6E does not include support posts 18. Instead, the movable reflective layer 14 contacts the underlying optical stack 16 at multiple locations, and the curvature of the movable reflective layer 14 provides sufficient support that the movable reflective layer 14 returns to the unactuated position of FIG. 6E when the voltage across the interferometric modulator is insufficient to cause actuation. The optical stack 16, which may contain a plurality of several different layers, is shown here for clarity including an optical absorber 16a, and a dielectric 16b. In some implementations, the optical absorber 16a may serve both as a fixed electrode and as a partially reflective layer.

In implementations such as those shown in FIGS. 6A-6E, the IMODs function as direct-view devices, in which images are viewed from the front side of the transparent substrate 20, i.e., the side opposite to that upon which the modulator is arranged. In these implementations, the back portions of the device (that is, any portion of the display device behind the movable reflective layer 14, including, for example, the deformable layer 34 illustrated in FIG. 6C) can be configured and operated upon without impacting or negatively affecting the image quality of the display device, because the reflective layer 14 optically shields those portions of the device. For example, in some implementations a bus structure (not illustrated) can be included behind the movable reflective layer 14 which provides the ability to separate the optical properties of the modulator from the electromechanical properties of the modulator, such as voltage addressing and the movements that result from such addressing. Additionally, the implementations of FIGS. 6A-6E can simplify processing, such as, e.g., patterning.

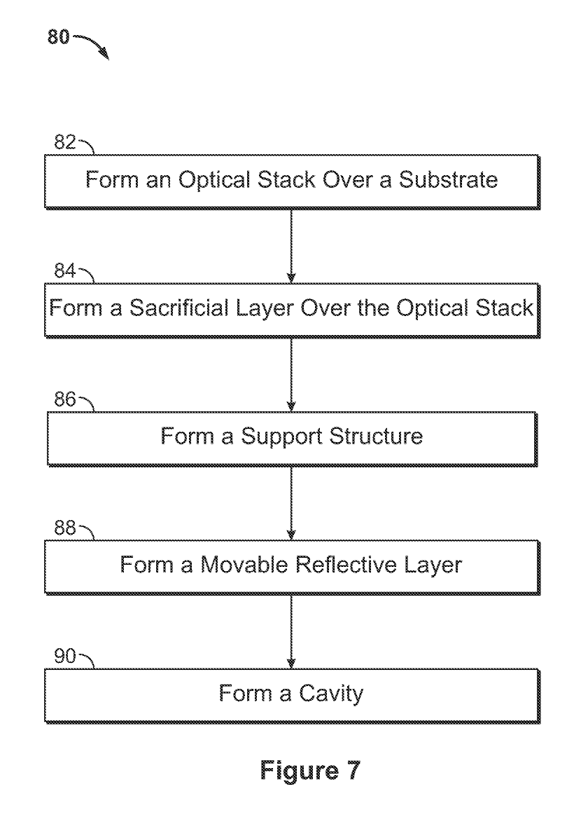

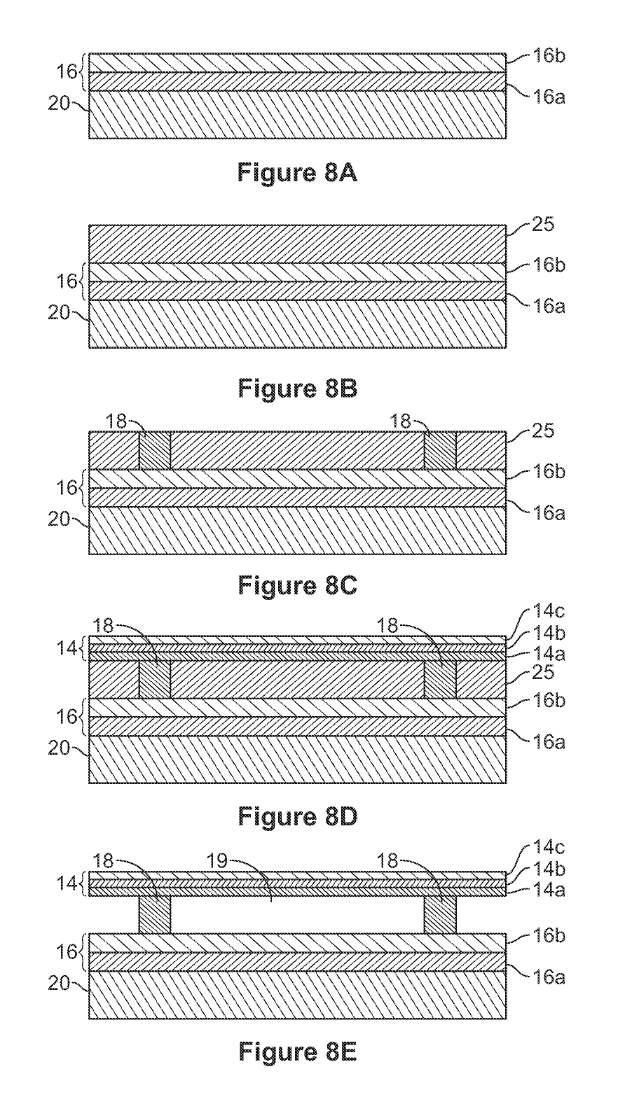

FIG. 7 shows an example of a flow diagram illustrating a manufacturing process 80 for an interferometric modulator, and FIGS. 8A-8E show examples of cross-sectional schematic illustrations of corresponding stages of such a manufacturing process 80. In some implementations, the manufacturing process 80 can be implemented to manufacture, e.g., interferometric modulators of the general type illustrated in FIGS. 1 and 6, in addition to other blocks not shown in FIG. 7. With reference to FIGS. 1, 6 and 7, the process 80 begins at block 82 with the formation of the optical stack 16 over the substrate 20. FIG. 8A illustrates such an optical stack 16 formed over the substrate 20. The substrate 20 may be a transparent substrate such as glass or plastic, it may be flexible or relatively stiff and unbending, and may have been subjected to prior preparation processes, e.g., cleaning, to facilitate efficient formation of the optical stack 16. As discussed above, the optical stack 16 can be electrically conductive, partially transparent and partially reflective and may be fabricated, for example, by depositing one or more layers having the desired properties onto the transparent substrate 20. In FIG. 8A, the optical stack 16 includes a multilayer structure having sub-layers 16a and 16b, although more or fewer sub-layers may be included in some other implementations. In some implementations, one of the sub-layers 16a, 16b can be configured with both optically absorptive and conductive properties, such as the combined conductor/absorber sub-layer 16a. Additionally, one or more of the sub-layers 16a, 16b can be patterned into parallel strips, and may form row electrodes in a display device. Such patterning can be performed by a masking and etching process or another suitable process known in the art. In some implementations, one of the sub-layers 16a, 16b can be an insulating or dielectric layer, such as sub-layer 16b that is deposited over one or more metal layers (e.g., one or more reflective and/or conductive layers). In addition, the optical stack 16 can be patterned into individual and parallel strips that form the rows of the display.

The process 80 continues at block 84 with the formation of a sacrificial layer 25 over the optical stack 16. The sacrificial layer 25 is later removed (e.g., at block 90) to form the cavity 19 and thus the sacrificial layer 25 is not shown in the resulting interferometric modulators 12 illustrated in FIG. 1. FIG. 8B illustrates a partially fabricated device including a sacrificial layer 25 formed over the optical stack 16. The formation of the sacrificial layer 25 over the optical stack 16 may include deposition of a xenon difluoride (XeF₂)-etchable material such as molybdenum (Mo) or amorphous silicon (a-Si), in a thickness selected to provide, after subsequent removal, a gap or cavity 19 (see also FIGS. 1 and 8E) having a desired design size. Deposition of the sacrificial material may be carried out using deposition techniques such as physical vapor deposition (PVD, e.g., sputtering), plasma-enhanced chemical vapor deposition (PECVD), thermal chemical vapor deposition (thermal CVD), or spin-coating.

The process 80 continues at block 86 with the formation of a support structure e.g., a post 18 as illustrated in FIGS. 1, 6 and 8C. The formation of the post 18 may include patterning the sacrificial layer 25 to form a support structure aperture, then depositing a material (e.g., a polymer or an inorganic material, e.g., silicon oxide) into the aperture to form the post 18, using a deposition method such as PVD, PECVD, thermal CVD, or spin-coating. In some implementations, the support structure aperture formed in the sacrificial layer can extend through both the sacrificial layer 25 and the optical stack 16 to the underlying substrate 20, so that the lower end of the post 18 contacts the substrate 20 as illustrated in FIG. 6A. Alternatively, as depicted in FIG. 8C, the aperture formed in the sacrificial layer 25 can extend through the sacrificial layer 25, but not through the optical stack 16. For example, FIG. 8E illustrates the lower ends of the support posts 18 in contact with an upper surface of the optical stack 16. The post 18, or other support structures, may be formed by depositing a layer of support structure material over the sacrificial layer 25 and patterning portions of the support structure material located away from apertures in the sacrificial layer 25. The support structures may be located within the apertures, as illustrated in FIG. 8C, but also can, at least partially, extend over a portion of the sacrificial layer 25. As noted above, the patterning of the sacrificial layer 25 and/or the support posts 18 can be performed by a patterning and etching process, but also may be performed by alternative etching methods.

The process 80 continues at block 88 with the formation of a movable reflective layer or membrane such as the movable reflective layer 14 illustrated in FIGS. 1, 6 and 8D. The movable reflective layer 14 may be formed by employing one or more deposition steps, e.g., reflective layer (e.g., aluminum, aluminum alloy) deposition, along with one or more patterning, masking, and/or etching steps. The movable reflective layer 14 can be electrically conductive, and referred to as an electrically conductive layer. In some implementations, the movable reflective layer 14 may include a plurality of sub-layers 14a, 14b, 14c as shown in FIG. 8D. In some implementations, one or more of the sub-layers, such as sub-layers 14a, 14c, may include highly reflective sub-layers selected for their optical properties, and another sub-layer 14b may include a mechanical sub-layer selected for its mechanical properties. Since the sacrificial layer 25 is still present in the partially fabricated interferometric modulator formed at block 88, the movable reflective layer 14 is typically not movable at this stage. A partially fabricated IMOD that contains a sacrificial layer 25 may also be referred to herein as an “unreleased” IMOD. As described above in connection with FIG. 1, the movable reflective layer 14 can be patterned into individual and parallel strips that form the columns of the display.

The process 80 continues at block 90 with the formation of a cavity, e.g., cavity 19 as illustrated in FIGS. 1, 6 and 8E. The cavity 19 may be formed by exposing the sacrificial material 25 (deposited at block 84) to an etchant. For example, an etchable sacrificial material such as Mo or amorphous Si may be removed by dry chemical etching, e.g., by exposing the sacrificial layer 25 to a gaseous or vaporous etchant, such as vapors derived from solid XeF₂ for a period of time that is effective to remove the desired amount of material, typically selectively removed relative to the structures surrounding the cavity 19. Other etching methods, e.g. wet etching and/or plasma etching, also may be used. Since the sacrificial layer 25 is removed during block 90, the movable reflective layer 14 is typically movable after this stage. After removal of the sacrificial material 25, the resulting fully or partially fabricated IMOD may be referred to herein as a “released” IMOD.

Displays such as interferometric modulator displays use reflected light to produce an image. In a dark or low-light environment, e.g., some indoor or nighttime environments, there may be insufficient ambient light to generate a useful image. Front lights may be used in such environments to augment or substitute for ambient light. The front light can be disposed forward of display elements of the display and can redirect light from a light source backwards towards the display elements. The light is reflected forward, past the front light, and towards, e.g., the viewer to produce a viewable image.

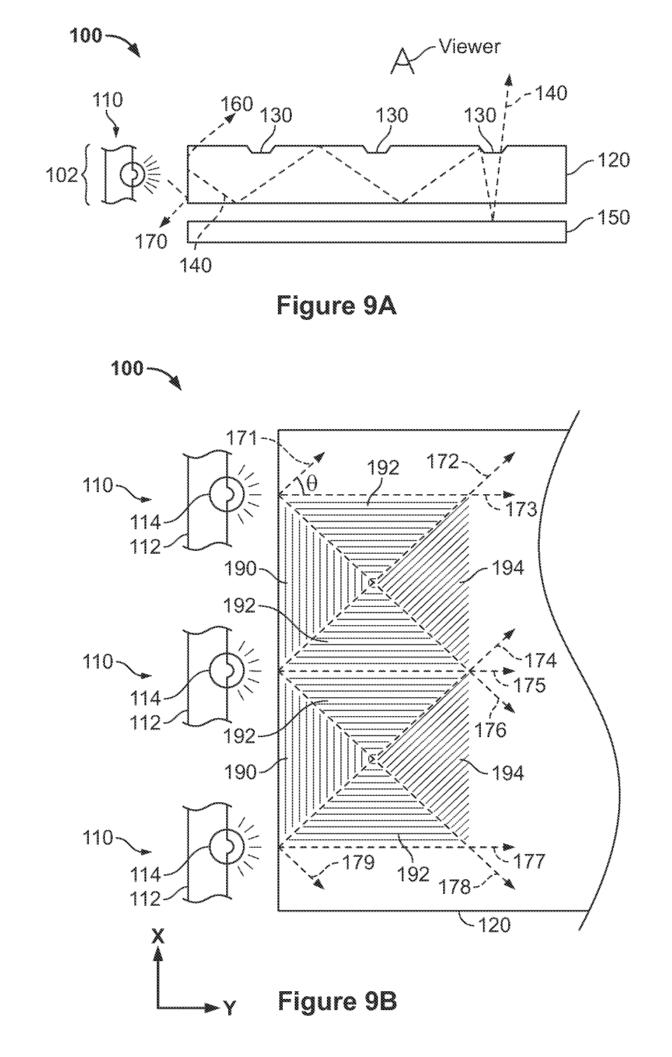

FIG. 9A shows an example of a cross section of a display system 100 that includes a front light 102. A light source 110 injects light into a side (for example, the left side, although other sides are within the scope of the invention, including multiple sides) of a light guide 120. The light propagates from the left side (in this example) of the light guide 120 towards the right side. The light may be reflected across the light guide 120 by total internal reflection and may be ejected out of the light guide 120 by reflection off a light turning feature 130. For example, a light ray 140 may be injected into the light guide 120, where it may impinge on boundaries of the light guide 120 so that it propagates through the light guide 120 by total internal reflection (TIR). Upon impinging on one of the light turning features 130, the light ray 140 may be reflected towards display elements of a display 150 provided behind the light guide 120. The display 150 then reflects the light forwards towards a viewer. The display elements can include interferometric modulators, such as the interferometric modulators 12 (FIG. 1).

Light from the light source 110 can be injected into the light guide 120 in a wide range of angles. As a result, not all of this light may be injected into the light guide 120 at angles for which TIR will occur. Some of the light, such as a ray 160, may simply pass through the light guide 120 and exit without being reflected. Other light rays 170 may be incident the light guide 120 at angles that cause them to be externally reflected, rather than entering into the light guide 120. Consequently, some of the light output of the light source 110 is “wasted” in the sense that the wasted light does not enter or exit the light guide 120 without being directed towards the display 150. As a result, the display 150 appears darker to the viewer than it otherwise might for a light source 110 having a given light output.

FIG. 9B shows an example of a top-down view of the display system 100 of FIG. 9A. The display system 100 can include an array of light sources 110 and the light guide 120. Although three light sources 110 are shown in FIG. 9B, a person having ordinary skill in the art will appreciate than any number of light sources can be used.

In some implementations, each light source 110 can include a package 112 and a light emitter 114, from which light directly emits light. The light emitters 114 can occupy a smaller area than the packages 112, which can include a housing or other structural and electrical components to support and facilitate light emission from a light emitter 114. In various implementations, the light emitters 114 can be substantially smaller than the packages 112 such as, for example, less than half as long, less than one-third as long, or less than one-fourth as long as the packages 112. Accordingly, the size of the packages 112 may limit the number of light sources 110 that can fit along the side of the light guide 120 into which light is injected.

In some implementations, the light emitters 114 can be configured to inject light into the light guide 120 at various angles. For example, the light emitters 114 can inject rays 171-179 into the light guide 120. In some implementations, the refractive index of the light guide 120 may limit the angles at which the light emitters 114 can inject light into the light guide 120. For example, the light emitters 114 may not be capable of injecting a desired amount of light into the light guide 120 at an angle greater than the angle θ, since the difference in refractive index between the light guide 120 and an air gap separating the light guide and the light sources 110 can cause a larger portion of light incident on the light guide 120 at some angles to be reflected, rather being injected into the light guide.

Because the light emitters 114 may not inject light into the light guide 120 at certain angles, various regions of the light guide 120 may receive more or less light due to varying overlap of light from each light emitter 114. The varying convergence of light from each light emitter 114 can cause optical artifacts, such as cross-hatch patterns. For example, areas 190 of the light guide 120 may receive relatively little light because they lie in between an illumination area of the light emitters 114. On the other hand, areas 192 may receive more light because they lie in the illumination area of at least one light emitter 114. Areas 194 may receive even more light because they in the illumination of at least two light emitters 114, and so on. In general, the farther apart the light sources are, the larger and more visible the areas 190, 192, and 194 will be.

In some implementations, a manifold can be used to address the problems noted with regards to FIGS. 9A and 9B. For example, a manifold can effectively provide closely spaced virtual light sources, and hence, can restrict viewcones that cause cross hatch artifacts. In addition, the manifold may be used to collimate light, to increase brightness.

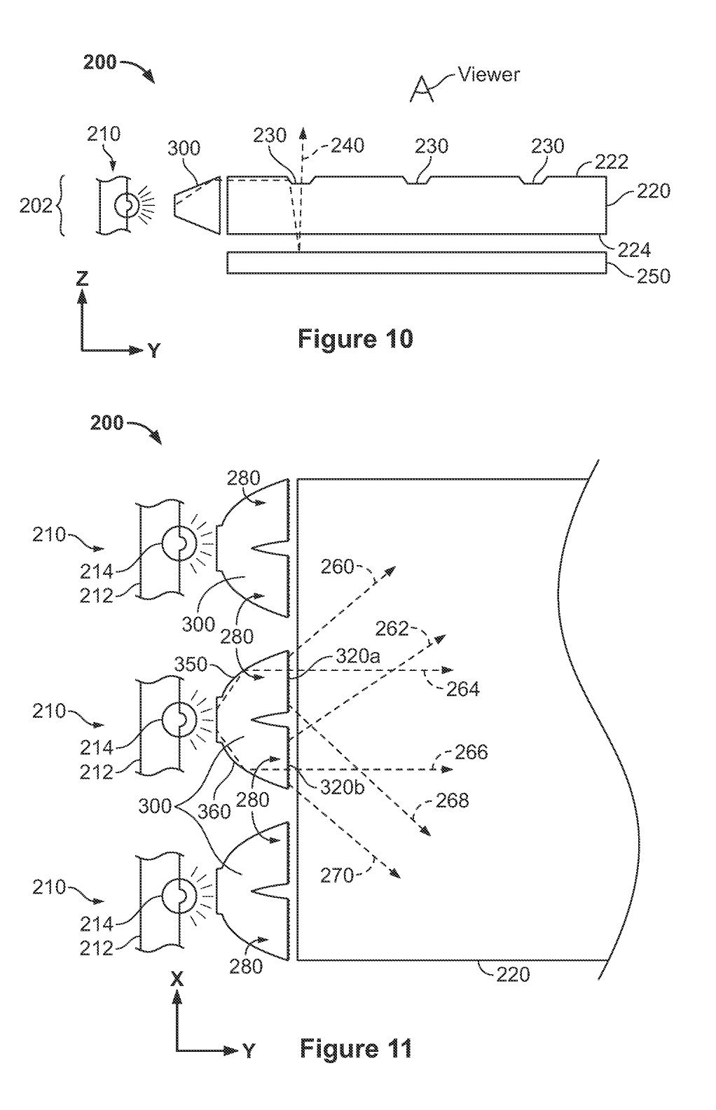

The collimation of light will now be discussed with reference to FIG. 10. FIG. 10 shows an example of a cross section of a display system 200 with a light manifold 300. The display system 200 can also include an illumination device 202, which may include one or more light sources 210, a manifold 300 and a light guide 220. The light source 210 generates light to be injected into the light guide 220 via the manifold 300. The manifold 300 may be configured to collimate light that would otherwise propagate in directions out of the plane of the light guide 220, so that the collimated light propagates in directions that are substantially parallel to the plane of the light guide 220 and/or the directions are within a relatively narrow range of angles that allow the light to be accepted into the light guide 220 and that allow for TIR within the light guide 220. In some implementations, light propagating in the plane of the light guide 220 is not collimated, or is collimated to a lesser extent, and propagates in a relatively wide range of angles within that plane, thereby giving a highly uniform light distribution in the light guide 220. The manifold 300 can increase the proportion of light from the light source 210 that propagates through the light guide 220 panel by total internal reflection, thereby increasing the light redirected to the display 250 and increasing the brightness of the display 250.

With continued reference to FIG. 10, the light sources 210 may be various light sources known in the art, such as light emitting diodes and/or fluorescent bulbs. The manifold 300 may directly interface with the light guide 220 or may inject light into the light guide 220 through intermediate coupling structures or layers of material. The light guide 220 can be formed of a material that supports the transmission and propagation of light. For example, the light guide 220 may be made of an optically transparent material and may take the form of a panel.

The light guide 220 can include a plurality of light turning features 230 having reflective surfaces for light turning. Part or all of the surfaces of the light turning features 230 may be coated with a reflective film, e.g., a metal film, or light turning may occur by total internal reflection. The horizontal and sloped surfaces of the light turning features 230 may meet at sharp corners. In some implementations, the corners of the light turning features 230 are curved, or rounded. The rounding reflects light off the light turning features 230 at a wider range of angles compared to reflections off sharp corners, which may increase the uniformity of light reflected off the light turning features 230, thereby increasing the uniformity of light across the light guide 220. Alternatively, or in addition to having rounded corners, the light turning features 230 may have a roughened surface. The roughened surface can scatter light and, hence, increases the uniformity of reflected light across the light guide 220.

In some implementations, light generated by the light source 210 can be collimated by the manifold 300 so that it is made more parallel to the major surfaces of the light guide 220 than when the light entered the manifold 300. Ray 240 is an example of such collimated light. The ray 240 propagates away from the light source 210, enters the manifold 300, and is collimated by the manifold 300, ejected from the manifold 300, and injected into the light guide 220. The ray 240 propagates through the light guide 220 and is redirected by the light turning feature 230 back to the display 250, where it is reflected forwards towards, e.g., a viewer. It will be appreciated that the display 250 may be provided with reflective display elements, such as the interferometric modulators 12 shown in FIG. 1.

The collimated ray 240 can be made more parallel to one or both of the major surfaces 222, 224 of the light guide panel 220 than when it entered into the manifold 300. One having ordinary skill in the art will readily appreciate that the collimated ray 240 may not be exactly parallel to the major surfaces 222, 224. For example, the collimated ray 240 may exit the manifold 300 at an angle relative to the major surfaces 222, 224. In some implementations, light can be ejected out of the manifold 300 at angles such that the light is sufficiently parallel to the major surfaces 222, 224 to undergo TIR within the light guide panel 220, or to be redirected by the light turning features 230.

FIG. 11 shows an example of a top-down view of the display system 200 of FIG. 10. The display system 200 can include an array of light sources 210 and manifolds 300. Although three pairs of light sources 210 and manifolds 300 are shown in FIG. 11, a person having ordinary skill in the art will appreciate than any number of light sources 210 and manifolds 300 can be used. The manifolds 300 may be configured such that light propagating in the plane of the light guide 220 is not collimated. For example, rays 260, 262, 264, 266, and 270 ejected from a manifold 300 and propagating in the plane of the light guide 220 may have a wide angular distribution, relative to the narrower angular distribution of the light such as the rays 240 propagating into the manifold 300 in directions extending out of the plane of the light guide 220 (as shown in FIG. 10).

In some implementations, each light source 210 can include a package 212 and a light emitter 214, from which light directly emits light. The light emitters 214 can occupy a smaller area than the packages 212, which can include a housing or other structural and electrical components to support and facilitate light emission from a light emitter 214. In various implementations, the light emitters 214 can be substantially smaller than the packages 212 such as, for example, less than half as long, less than one-third as long, or less than one-fourth as long as the packages 212. Accordingly, the size of the packages 212 may limit the number of light sources 210 that can fit along the side of the light guide 220 into which light is injected, as discussed herein.

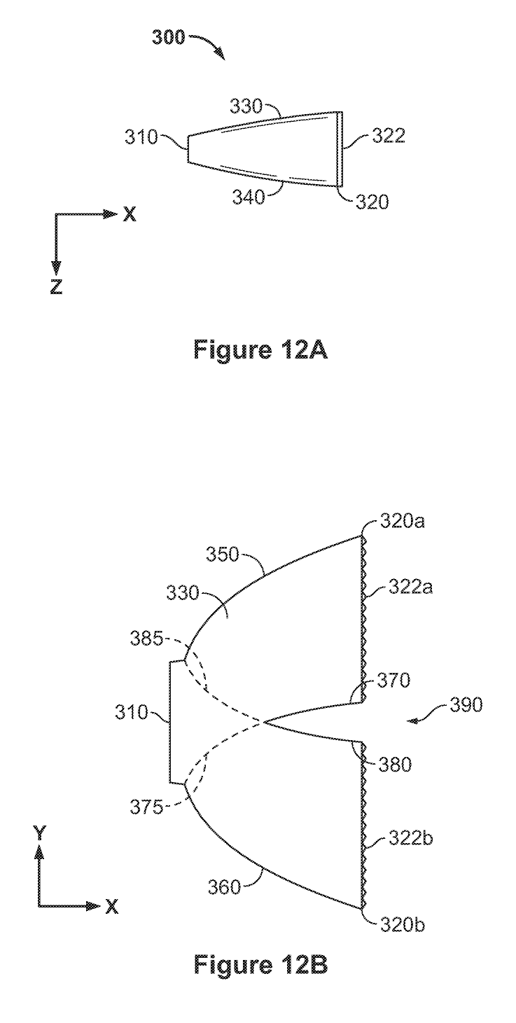

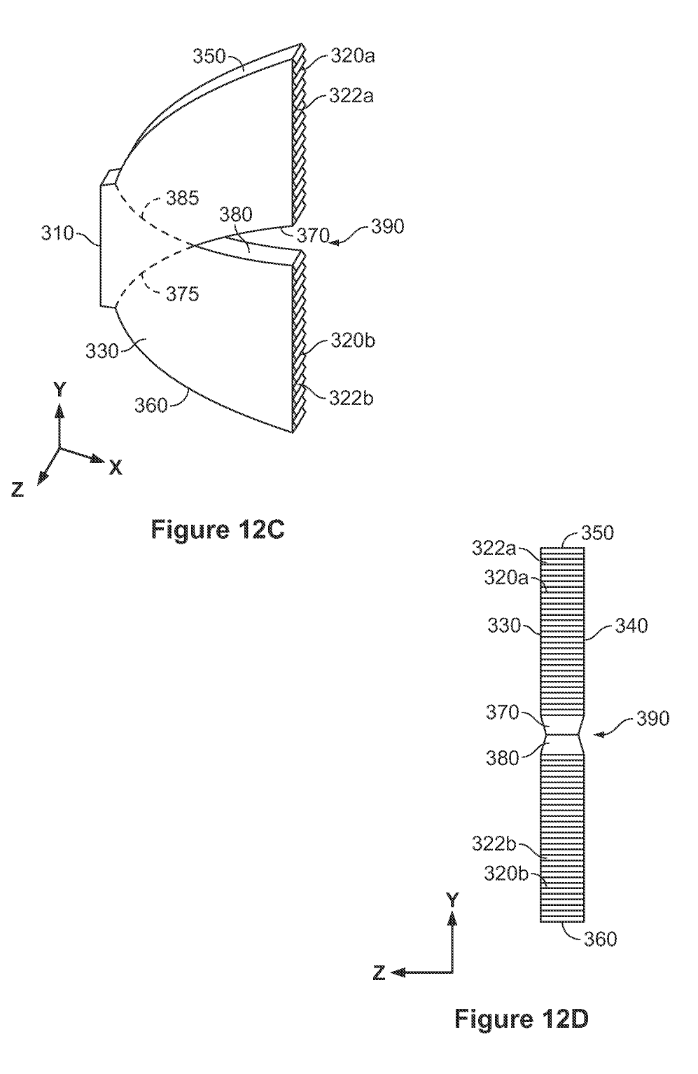

In some implementations, the manifolds 300 can be configured to split the light sources 210 into a plurality of virtual light sources 280. For example, the ray 264 can enter the manifold 300, reflect off a first sidewall 350, and exit the manifold 300 from a first output portion 320a of a front wall 320 (FIG. 12A). On the other hand, the ray 266 can enter the same manifold 300, reflect off a second sidewall 360, and exit the manifold 300 from a second output portion 320b of the front wall 320, separated from the first. As illustrated, in some implementations, the first and second sidewalls 350 and 360 are configured to reflect light from an associated light source 210 out of each of the first and second output portions 320a and 320b in a similar range of angles and intensities. For example, the halves of the manifold 280 containing the first and second output portions 320a and 320b can be symmetrical.

With continued reference to FIG. 11, the first output portion 320a and the second output portion 320b can act as the virtual light sources 280. Splitting the light sources 210 into the virtual light sources 280 can allow the virtual light sources 280 to be spaced closer to each other than the light sources 210 might otherwise permit. By injecting light into the light guide 220 through the closely-spaced virtual light sources 280, the appearance of optical artifacts, such as cross-hatch patterns (described above with respect to FIG. 9B), can be reduced relative to more widely spaced apart light sources.

FIGS. 12A-12D illustrate, respectively, examples of side, top-down, perspective and front views of the manifold 300. With reference to FIG. 12A, the manifold 300 has a backside 310 and a front wall 320 opposite the backside 310. An upper wall 330 and a lower wall 340 extend from the backside 310 to the front wall 320. In some implementations, a plurality of lens 322 may be provided on the front wall 320. With reference to FIG. 12B, sidewalls 350 and 360 can be seen in this top-down view. The manifold 300 can include a non-light emitting area 390. In the illustrated implementation, the non-light emitting area 390 includes a notch, formed from the inner sides 370 and 380, dividing the front wall 320 into a first output portion 320a and a second output portion 320b. The first output portion 320a and the second output portion 320b can be configured to output light from a light source, and the non-light emitting area 390 can be configured to substantially block light from the light source. As such, by tracing the optical paths of light output through the output portions 320a and 302b, the points of intersection of the optical paths traced can be referred to as the virtual light sources because it may appear to a viewer that the light output was generated by light sources at these points of intersection.

The non-light emitting area 390 can be formed from a first inner sidewall 370 and a second inner sidewall 380, in some implementations. The first and second inner sidewalls 370 and 380 can be curved. In some implementations, the curve of the first inner sidewall 370 can have substantially the same curvature as a portion of the curve of the first sidewall 350. In some implementations, the curve of the second inner sidewall 380 have the same curvature as a portion of the curve of the second sidewall 360. While the non-light emitting area 390 is shown in FIGS. 12A-12D as a gap or notch, the present disclosure is not limited to those structures. For example, in an implementation, the non-light emitting area 390 can be filled with or made of a solid, non-transmissive material. In another implementation, the non-light emitting area 390 can be a non-transmissive section of the front wall 320. For example, the non-light emitting area 390 of the front wall 320 could be coated with a reflective coating of opaque material.

With reference to FIGS. 12C and 12D, the front wall 320 may be provided with a plurality of lens 322 in some implementations. One having ordinary skill in the art will readily appreciate that the plurality of lens 322 may be configured to aid in redirecting and diffusing light. The lens 322 may take various forms, such as protrusions on the front wall 320, or a grating on the front wall 320. In some implementations, the lens 322 can include striped protrusions extending along the width of the front wall 320. Relative to a flat front wall 320, such striped protrusions can increase the range of angles that light is distributed in the plane of the light guide 220 (FIG. 11), while not significantly impacting the collimation of light in out-of-plane directions. For example, in the plane of the light guide 220, the protrusions can have a curved or angled cross-section that can cause exiting light to be widely dispersed, while in directions out of the plane, each surface of the protrusions can be roughly flat, which can have less impact on the dispersion of outputted light. The lens 322 may be integral with the front wall 320, for example, formed of the same material as the front wall 320 and defined by removing material from the front wall 320, or may be a structure attached to the front wall 320, for example, formed of the same or a different material as the front wall 320 and then adhered to the front wall 320.

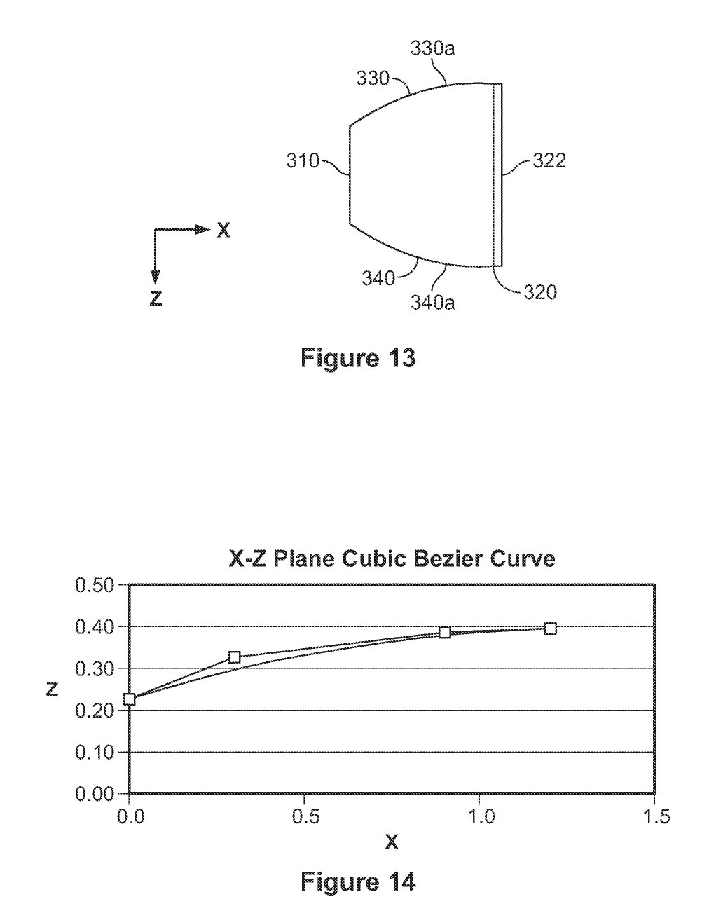

FIG. 13 shows an example of a cross-sectional side view of the manifold 300. The manifold 300 may be formed of a solid body of optically-transmissive material. The outer surface 330a of the upper wall 330 may be curved, as may the outer surface 340a of the lower wall 340. In some implementations, light striking the outer surfaces 330a and 340a can be reflected, with the shape of the curve determining the angle of reflectance. The curve may be chosen such that the reflected light is collimated. The reflection may occur by TIR. In some other implementations, a reflective coating may be applied on the surfaces 330a and 340a to increase the efficiency of the manifold 300 by reducing or preventing light losslosing out of the manifold 300 if that light does not undergo TIR. In addition, in some implementations, light striking other sidewalls, including the outer and inner sidewalls 350, 360, 370, and 380 (FIG. 12B) can be reflected, with the shape of the curve determining the angle of reflectance. The curve may be chosen such that the outputted reflected light is collimated. These reflection may also occur by TIR. As with the surfaces 330a and 340a, in some other implementations, a reflective coating may be applied on one or more surfaces of the and inner sidewalls 350, 360, 370, and 380 to increase the efficiency of the manifold 300 by preventing losing light out of the manifold 300 if that light does not undergo TIR.

The shape of the curve may be the same or different for each of the outer surfaces 330a and 340a. For example, where the light guide 220 (FIG. 10) has parallel major surfaces 222 and 224, the curve may be the same general shape (although flipped relative to one another), so that light ejected from the manifold 300 interacts similarly with both major surfaces 222 and 224. In some other implementations, if the major surfaces 222 and 224 are not parallel, the curves of the outer surfaces 330a and 340a may be different, for example, to ensure that light from the manifold 300 strikes each respective one of the major surfaces 222 and 224 at angles for which TIR occurs.

In some implementations, one or both of the outer surfaces 330a and 340a may extend along a Bezier curve flowing from the back side 310 to the front side 320. Moreover, in some implementations, one or both of the inner sidewalls 370 and 380 (FIG. 12B) may extend along a portion of similar Bezier curves 375 and 380, flowing from the back side 310 to the front side 320. In one example, the curve is a cubic Bezier curve having the parametric form below:

B(t)=(1−t)³P₀+3(1−t)²tP₁+3(1−t)t²P₂+t³P₃, t∈[0,1].

FIG. 14 illustrates an example of a Bezier curve along which one or both of the outer surfaces 330a and 340a may extend. FIG. 14 shows the curve of the outer surfaces 300a and 340a as viewed in cross-section on the X-Z plane. It will be appreciated that the curve for one surface is flipped upside-down, about the X-axis, relative to the curve for the other surface. The square points indicate control points for the curve and the curved line is the Bezier curve. The control points are provided in Table I below.

TABLE 1

| | | X | Z |
|---|---|---|---|
| Control | P₀ | 0 | 0.225 |
| Points | P₁ | 0.3 | 0.325 |
| | P₂ | 0.9 | 0.390 |
| | P₃ | 1.2 | 0.400 |

In some implementations, the Bezier curve has been found to facilitate the collimation of light propagating through the manifold 300. In some implementations, one or both of the inner sidewalls 370 and 380 (FIG. 12B) may extend along portions of Bezier curves 375 and 380 (described above with respect to FIG. 13), flowing from the back side 310 to the front side 320.

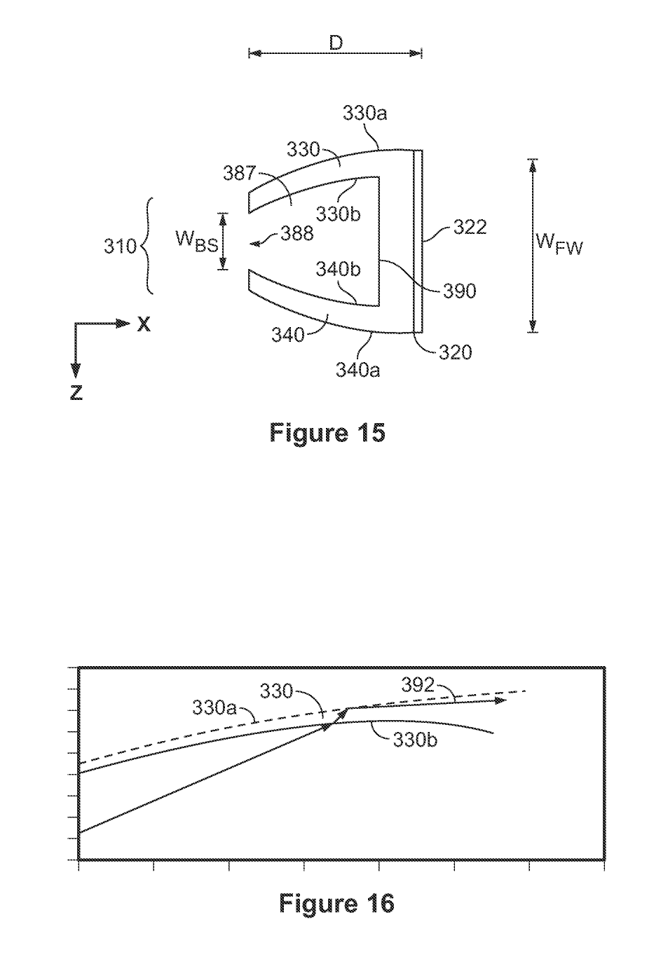

FIG. 15 shows an example of another cross-sectional side view of the manifold 300. The body of the manifold 300 may be hollowed out, thereby forming an internal cavity or volume 387. The cavity 387 opens to the backside 310 through an opening 388. The cavity 387 is defined by the inner surface 330b of the upper wall 330, the inner surface 340b of the lower wall 340 and the inner surface 390 of the front wall 320. As illustrated, the inner surface 390 may be flat. In some implementations, one or both of the inner surfaces 330b and 340b may be curved and may follow the same or different curves depending upon the desired direction of the light ejected by reflection off each surface. For example, the curves of the inner surfaces 330b and 340b can be different if the major surfaces 222 and 224 (FIG. 10) of the light guide 220 are non-parallel, so that light reflected off each of the inners surfaces 330b and 340b are substantially parallel to a corresponding one of the major surfaces 222 and 224.

In some implementations, the inner surfaces 330b and 340b extend along Bezier curves. The Bezier curve may be different from the curve along which the outer surfaces 330a, 340a extend. Similarly, the surfaces of the outer and inner sidewalls 350, 360, 370, and 380 (FIG. 12B) can extend along different Bezier curves. This may be accomplished by changing the central points for the curve. For example, the curve for the inner surfaces 330a and 330b can be configured such that the walls 330 and 340 thicken with increasing distance from the back side 310. An example of such an arrangement is shown in FIG. 16, which illustrates an example of a manifold sidewalls curve graph. The dotted line represents the curve of the outer surface 330a and the solid line represents the curve of the inner surface 330b. The curved inner and outer surfaces 330a and 330b are can be effective for collimating light, as illustrated by ray 392. The ray 392 strikes the inner surface 330b, is refracted by the material of the wall 330, and is reflected off the outer surface 330a. In some implementations, reflection off of the outer surface 330a can be by TIR or a reflective layer can be provided on that outer surface.

One having ordinary skill in the art will appreciate that the curvature of the inner and outer surfaces of the walls 330 and 340, and the outer and innter sidewalls 350, 360, 370, and 380, may take into account the refraction of light by the material forming those walls to provide the appropriate angles of reflection for light collimation. In some implementations, the refractive index of the material forming those walls is about 1.3 or more. In some other implementations, the refractive index is about 1.5 or more.

It will be appreciated that one or more of the sidewalls 350, 360, 370, and 380 (FIG. 12C) may also be curved as discussed herein for upper and lower walls 330 and 340. In some implementations, the curvature of the sidewalls 350, 360, 370, and 380 may be selected to provide a wide angular distribution for light reflected off the sidewalls. In addition, because collimation may not be desired for light incident on those sidewalls 350, 360, 370, and 380, in some implementations, the sidewalls 350, 360, 370, and 380 may be provided with reflective films (to thereby increase efficiency), while the upper and lower walls 330 and 340 are not provided with reflective films (to thereby increase the degree of collimation of light incident on those upper and lower walls).

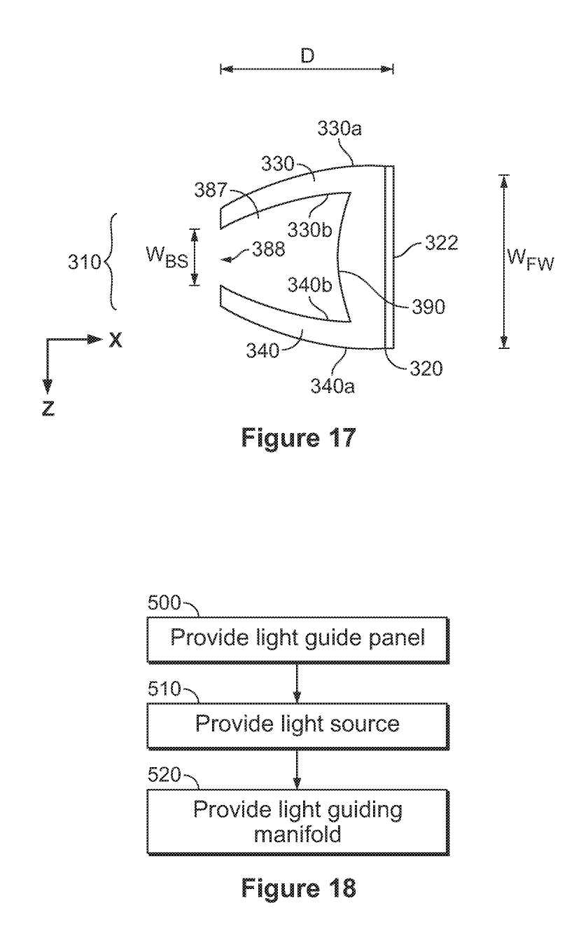

FIG. 17 shows another example of a cross sectional side view of a manifold. The inner surface 390 of the front wall 320 may be curved to further facilitate the collimation of light in the desired plane. In some implementations, the curvature may be convex.

With reference to FIGS. 15 and 17, to increase the efficiency of outputting light received from the light source 210 (FIG. 11), the outer surfaces 330a and 340a, the inner surfaces 330b and 340b, the outer sidewalls 350 and 360 (FIGS. 12A-12D), and/or the inner sidewalls 370 and 380 may be coated with a reflective film. In some implementations, the outer surfaces 330a, 340a are coated with the reflective film, to allow refraction by the walls 330 and 340 as shown in FIG. 16. In other implementations, one or more of the walls 330, 340, 350, 360, 370, and 380 are provided without any reflective film. It has been found that omitting a reflective film can facilitate a higher degree of collimination. For example, omitting the film can increase the degree of collimination by about 38% or more relative to providing the film in some implementations, since a reflective film will reflect light at all incident angles and since the curvature of the manifold walls may not be specifically configured to achieve collimination of light from all of those incident angles. On the other hand, TIR will reflect light which is incident the manifold walls at a relatively narrow band of angles, thereby allowing the curvature of the walls of the manifold 300 to be more specifically configured to collimate that light, and thereby increasing the degree of collimination for the light that is reflected.

One having ordinary skill in the art also will appreciate that the manifold 300 provides a very compact light collimation structure. With reference again to FIGS. 16 and 17, the openings 388 have a width W_{BS} and the front wall 320 has a width W_{FW} and the manifold 300 has a depth D. Advantageously, in some implementations, the ratio of W_{FW} to W_{BS} may be about 2.5:1 or less, about 2:1 or less, or about 1.7:1 or less. In addition, the manifold 300 can be configured to be relatively shallow. In some implementations, the ratio of D to W_{BS} may be about 5:1 or less, or about 3:1 or less. For example, in some implementations, W_{FW} can be about 0.8 mm and W_{BS} can be about 0.45 mm. In some implementations, W_{BS} can be selected to match the size of the light emitter 214 (FIG. 11). Similarly, W_{FW} can be selected to match a thickness of the light guide 220.

Various modifications to the implementations described herein are possible. For example, the light turning features 230 can be on one or both surfaces of the light guide 220 (FIG. 9A). Also, light turning features other than the light turning features 230 may be utilized to direct light to the display 250. For example, holographic light turning features also may be employed.

Also, the illumination device 202 (FIG. 10) may be applied as a backlight. Instead of being situated in front of a display 250 that reflects light forward past the light guide 220, the light guide 220 may be disposed behind the display 250 and direct light forward through the display elements of the display 260 and towards, for example, a viewer.

FIG. 18 is an example of a method for manufacturing a display system. Although the method of FIG. 18 is described herein with reference to the display system 200 discussed above with respect to FIGS. 10 and 11, a person having ordinary skill in the art will appreciate that the method of FIG. 18 may be implemented by and/or any other suitable system. Although the method of FIG. 18 is described herein with reference to a particular order, in various embodiments, blocks herein may be performed in a different order, or omitted, and additional blocks may be added.

Referring still to FIG. 18, first, the light guide 220 (FIG. 10) is provided at block 500. In some implementations, providing the light guide 220 can include forming a plurality of light turning features 230 in an optically transmissive panel, the optically transmissive panel forming the light guide 220. In some implementations, the display 250 is provided under the light guide 220. The display 250 can include a plurality of interferometric modulators, and the interferometric modulators can form pixels of the display 250.

Next, the light source is provided at block 510. In some implementations, the light source may be the light source 210 of FIG. 10. Then, the light collimating manifold 300 is provided at block 520. The light collimating manifold 300 is provided between the light source 210 and the light guide 220. The light collimating manifold 300 is configured to output light from the light source in a relatively narrow angular distribution out of a plane of the light guide panel and a relatively wide angular distribution in the plane of the light guide panel. The light collimating manifold 300 is further configured to produce a plurality of virtual light sources 280 (FIG. 11) from the light of the light source 210. In some implementations, providing the manifold 300 can include hollowing out the manifold body to define the manifold body internal cavity 387 (FIG. 15) opening to the backside through the opening 388.

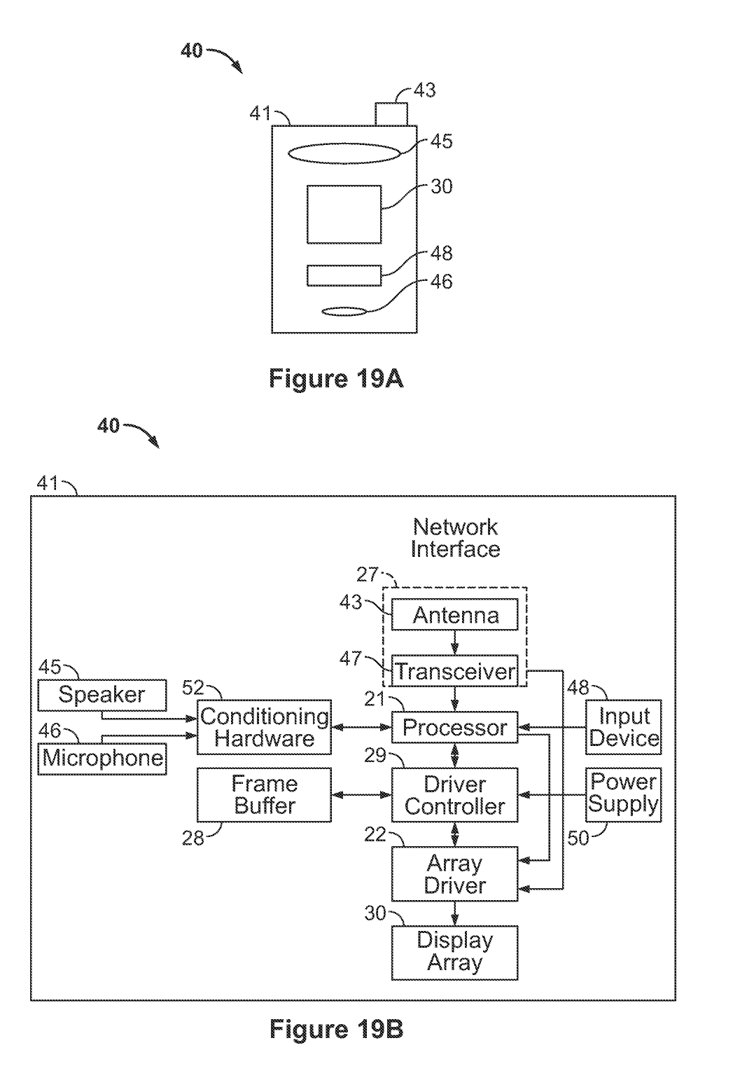

FIGS. 19A and 19B show examples of system block diagrams illustrating a display device 40 that includes a plurality of interferometric modulators. The display device 40 can be, for example, a cellular or mobile telephone. However, the same components of the display device 40 or slight variations thereof are also illustrative of various types of display devices such as televisions, e-readers and portable media players.

The display device 40 includes a housing 41, a display 30, an antenna 43, a speaker 45, an input device 48, and a microphone 46. The housing 41 can be formed from any of a variety of manufacturing processes, including injection molding, and vacuum forming. In addition, the housing 41 may be made from any of a variety of materials, including, but not limited to: plastic, metal, glass, rubber, and ceramic, or a combination thereof. The housing 41 can include removable portions (not shown) that may be interchanged with other removable portions of different color, or containing different logos, pictures, or symbols.

The display 30 may be any of a variety of displays, including a bi-stable or analog display, as described herein. The display 30 also can be configured to include a flat-panel display, such as plasma, EL, OLED, STN LCD, or TFT LCD, or a non-flat-panel display, such as a CRT or other tube device. In addition, the display 30 can include an interferometric modulator display, as described herein.

The components of the display device 40 are schematically illustrated in FIG. 19B. The display device 40 includes a housing 41 and can include additional components at least partially enclosed therein. For example, the display device 40 includes a network interface 27 that includes an antenna 43 which is coupled to a transceiver 47. The transceiver 47 is connected to a processor 21, which is connected to conditioning hardware 52. The conditioning hardware 52 may be configured to condition a signal (e.g., filter a signal). The conditioning hardware 52 is connected to a speaker 45 and a microphone 46. The processor 21 is also connected to an input device 48 and a driver controller 29. The driver controller 29 is coupled to a frame buffer 28, and to an array driver 22, which in turn is coupled to a display array 30. A power supply 50 can provide power to all components as required by the particular display device 40 design.

The network interface 27 includes the antenna 43 and the transceiver 47 so that the display device 40 can communicate with one or more devices over a network. The network interface 27 also may have some processing capabilities to relieve, e.g., data processing requirements of the processor 21. The antenna 43 can transmit and receive signals. In some implementations, the antenna 43 transmits and receives RF signals according to the IEEE 16.11 standard, including IEEE 16.11(a), (b), or (g), or the IEEE 802.11 standard, including IEEE 802.11a, b, g or n. In some other implementations, the antenna 43 transmits and receives RF signals according to the BLUETOOTH standard. In the case of a cellular telephone, the antenna 43 is designed to receive code division multiple access (CDMA), frequency division multiple access (FDMA), time division multiple access (TDMA), Global System for Mobile communications (GSM), GSM/General Packet Radio Service (GPRS), Enhanced Data GSM Environment (EDGE), Terrestrial Trunked Radio (TETRA), Wideband-CDMA (W-CDMA), Evolution Data Optimized (EV-DO), NEV-DO, EV-DO Rev A, EV-DO Rev B, High Speed Packet Access (HSPA), High Speed Downlink Packet Access (HSDPA), High Speed Uplink Packet Access (HSUPA), Evolved High Speed Packet Access (HSPA+), Long Term Evolution (LTE), AMPS, or other known signals that are used to communicate within a wireless network, such as a system utilizing 3G or 4G technology. The transceiver 47 can pre-process the signals received from the antenna 43 so that they may be received by and further manipulated by the processor 21. The transceiver 47 also can process signals received from the processor 21 so that they may be transmitted from the display device 40 via the antenna 43.

In some implementations, the transceiver 47 can be replaced by a receiver. In addition, the network interface 27 can be replaced by an image source, which can store or generate image data to be sent to the processor 21. The processor 21 can control the overall operation of the display device 40. The processor 21 receives data, such as compressed image data from the network interface 27 or an image source, and processes the data into raw image data or into a format that is readily processed into raw image data. The processor 21 can send the processed data to the driver controller 29 or to the frame buffer 28 for storage. Raw data typically refers to the information that identifies the image characteristics at each location within an image. For example, such image characteristics can include color, saturation, and gray-scale level.

The processor 21 can include a microcontroller, CPU, or logic unit to control operation of the display device 40. The conditioning hardware 52 may include amplifiers and filters for transmitting signals to the speaker 45, and for receiving signals from the microphone 46. The conditioning hardware 52 may be discrete components within the display device 40, or may be incorporated within the processor 21 or other components.

The driver controller 29 can take the raw image data generated by the processor 21 either directly from the processor 21 or from the frame buffer 28 and can re-format the raw image data appropriately for high speed transmission to the array driver 22. In some implementations, the driver controller 29 can re-format the raw image data into a data flow having a raster-like format, such that it has a time order suitable for scanning across the display array 30. Then the driver controller 29 sends the formatted information to the array driver 22. Although a driver controller 29, such as an LCD controller, is often associated with the system processor 21 as a stand-alone Integrated Circuit (IC), such controllers may be implemented in many ways. For example, controllers may be embedded in the processor 21 as hardware, embedded in the processor 21 as software, or fully integrated in hardware with the array driver 22.

The array driver 22 can receive the formatted information from the driver controller 29 and can re-format the video data into a parallel set of waveforms that are applied many times per second to the hundreds, and sometimes thousands (or more), of leads coming from the display's x-y matrix of pixels.

In some implementations, the driver controller 29, the array driver 22, and the display array 30 are appropriate for any of the types of displays described herein. For example, the driver controller 29 can be a conventional display controller or a bi-stable display controller (e.g., an IMOD controller). Additionally, the array driver 22 can be a conventional driver or a bi-stable display driver (e.g., an IMOD display driver). Moreover, the display array 30 can be a conventional display array or a bi-stable display array (e.g., a display including an array of IMODs). In some implementations, the driver controller 29 can be integrated with the array driver 22. Such an implementation is common in highly integrated systems such as cellular phones, watches and other small-area displays.

In some implementations, the input device 48 can be configured to allow, e.g., a user to control the operation of the display device 40. The input device 48 can include a keypad, such as a QWERTY keyboard or a telephone keypad, a button, a switch, a rocker, a touch-sensitive screen, or a pressure- or heat-sensitive membrane. The microphone 46 can be configured as an input device for the display device 40. In some implementations, voice commands through the microphone 46 can be used for controlling operations of the display device 40.

The power supply 50 can include a variety of energy storage devices as are well known in the art. For example, the power supply 50 can be a rechargeable battery, such as a nickel-cadmium battery or a lithium-ion battery. The power supply 50 also can be a renewable energy source, a capacitor, or a solar cell, including a plastic solar cell or solar-cell paint. The power supply 50 also can be configured to receive power from a wall outlet.

In some implementations, control programmability resides in the driver controller 29 which can be located in several places in the electronic display system. In some other implementations, control programmability resides in the array driver 22. The above-described optimization may be implemented in any number of hardware and/or software components and in various configurations.

The various illustrative logics, logical blocks, modules, circuits and algorithm steps described in connection with the implementations disclosed herein may be implemented as electronic hardware, computer software, or combinations of both. The interchangeability of hardware and software has been described generally, in terms of functionality, and illustrated in the various illustrative components, blocks, modules, circuits and steps described above. Whether such functionality is implemented in hardware or software depends upon the particular application and design constraints imposed on the overall system.

The hardware and data processing apparatus used to implement the various illustrative logics, logical blocks, modules and circuits described in connection with the aspects disclosed herein may be implemented or performed with a general purpose single- or multi-chip processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, or, any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. In some implementations, particular steps and methods may be performed by circuitry that is specific to a given function.

In one or more aspects, the functions described may be implemented in hardware, digital electronic circuitry, computer software, firmware, including the structures disclosed in this specification and their structural equivalents thereof, or in any combination thereof. Implementations of the subject matter described in this specification also can be implemented as one or more computer programs, i.e., one or more modules of computer program instructions, encoded on a computer storage media for execution by, or to control the operation of, data processing apparatus.

Various modifications to the implementations described in this disclosure may be readily apparent to those skilled in the art, and the generic principles defined herein may be applied to other implementations without departing from the spirit or scope of this disclosure. Thus, the claims are not intended to be limited to the implementations shown herein, but are to be accorded the widest scope consistent with this disclosure, the principles and the novel features disclosed herein. The word “exemplary” is used exclusively herein to mean “serving as an example, instance, or illustration.” Any implementation described herein as “exemplary” is not necessarily to be construed as preferred or advantageous over other implementations. Additionally, a person having ordinary skill in the art will readily appreciate, the terms “upper” and “lower” are sometimes used for ease of describing the figures, and indicate relative positions corresponding to the orientation of the figure on a properly oriented page, and may not reflect the proper orientation of the IMOD as implemented.

Certain features that are described in this specification in the context of separate implementations also can be implemented in combination in a single implementation. Conversely, various features that are described in the context of a single implementation also can be implemented in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Further, the drawings may schematically depict one more example processes in the form of a flow diagram. However, other operations that are not depicted can be incorporated in the example processes that are schematically illustrated. For example, one or more additional operations can be performed before, after, simultaneously, or between any of the illustrated operations. In certain circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products. Additionally, other implementations are within the scope of the following claims. In some cases, the actions recited in the claims can be performed in a different order and still achieve desirable results.

What is claimed is:

1. A manifold system configured to produce virtual light sources, comprising:
an elongated manifold body of optically-transmissive material, the body including:
a backside configured to receive light from a light source;
a front wall opposite the backside and configured to output light from the light source, the front wall including first and second output portions separated by a non-light emitting area;
a curved upper wall extending from the backside to the front wall;
a curved lower wall extending from the backside to the front wall;
a first curved side wall extending from the backside to the front wall; and
a second curved side wall extending from the backside to the front wall,

2. The system of claim 1, wherein the body is configured to output light in a plane defined by a first axis extending horizontally along a length of the front wall and a second axis extending from the backside to the front wall of the body, wherein the light has a relatively narrow angular distribution on axes out of the plane, relative to an angular distribution of light in the plane.

3. The system of claim 1, wherein the non-light emitting area includes a notch having at least two curved sides extending towards the backside, the notch separating the first and second output portions of the front wall.

4. The system of claim 3, wherein the first and second output portions of the first wall are configured to produce virtual light sources.

5. The system of claim 3, wherein the sides of the notch are each coated with a reflective material.

6. The system of claim 1, wherein the elongated body has one or more inner walls defining a hollow internal volume with an opening to a hole on the backside.

7. The system of claim 1, further including a plurality of lenses on the front wall of the body.

8. The system of claim 7, wherein a side of one of the first and second portions of the front wall opposite the lenses is curved.

9. The system of claim 8, wherein the side of one of the first and second portions of the front wall opposite the lenses has a convex shape.

10. The system of claim 1, further including a plurality of lenses on the front wall of the body.

11. The system of claim 1, wherein the first and second side walls extend along a Bezier curve from the backside to the front wall.

12. The system of claim 1, wherein the first and second side walls are each coated with a reflective material.

13. The system of claim 1, further including the light source in optical communication with the backside.

14. The system of claim 13, wherein the front wall is configured to output light from the light source to an optically-transmissive panel.

15. The system of claim 14, wherein the optically-transmissive panel includes light turning features configured to turn light propagating inside the panel such that the light propagates out of a major surface of the panel.

16. The system of claim 15, further including a display having a major display surface facing the major surface of the panel, wherein the light turning features are configured to turn light out of the panel and towards the display.

17. The system of claim 16, wherein the display includes reflective display elements.

18. The system of claim 17, wherein the reflective display elements include interferometric modulators.

19. The system of claim 16, further comprising:
a processor that is configured to communicate with the display, the processor being configured to process image data; and
a memory device that is configured to communicate with the processor.

20. The system as recited in claim 19, further comprising:
a driver circuit configured to send at least one signal to the display; and
a controller configured to send at least a portion of the image data to the driver circuit.

21. The system as recited in claim 19, further comprising:
an image source module configured to send the image data to the processor.

22. The system as recited in claim 21, wherein the image source module includes at least one of a receiver, transceiver, and transmitter.

23. The system as recited in claim 19, further comprising:
an input device configured to receive input data and to communicate the input data to the processor.

24. A display device, comprising:
an array of display elements;
a light source;
a light guide having light turning features configured to redirect light generated by the light source towards the array of display elements; and
a virtual light generating means for generating a plurality of virtual light sources from the light source.

25. The display device of claim 24, wherein the virtual light generating means is configured to collimate light generated by the light source and output the collimated light in a plane defined by a first axis extending horizontally along a length of the front wall and a second axis extending from the backside to the front wall of the body, wherein the light has a relatively narrow angular distribution on axes out of the plane, relative to an angular distribution of light in the plane, wherein the virtual light generating means is positioned to output the collimated light into the light guide.

26. The device of claim 24, wherein the array of display elements includes interferometric modulators.

27. The device of claim 24, wherein the collimating means includes:
an elongated manifold body of optically-transmissive material, the body including:
a backside configured to receive light from the light source;
a front wall opposite the backside and configured to output light from the light source to the light turning feature, the front wall including first and second output portions separated by a non-light emitting area;
a curved upper wall extending from the backside to the front wall;
a curved lower wall extending from the backside to the front wall; and
a first curved side wall extending from the backside to the front wall; and
a second curved side wall extending from the backside to the front wall.

28. A method of manufacturing a display device, comprising:
providing a light guide panel;
providing a light source; and
providing a light collimating manifold between the light source and the light guide panel,
wherein the light collimating manifold is configured to output light from first and second output portions separated by a non-light emitting area.

29. The method of claim 28, wherein the light collimating manifold is configured to output light from the light source in a relatively narrow angular distribution out of a plane of the light guide panel, relative to an angular distribution of light in the plane of the light guide panel.

30. The method of claim 28, wherein the light collimating manifold includes:
an elongated manifold body of optically-transmissive material, the manifold body including:
a backside configured to receive light from a light source;
a front wall opposite the backside and configured to output light from the light source, the front wall including first and second output portions separated by a non-light emitting area;
a curved upper wall extending from the backside to the front wall;
a curved lower wall extending from the backside to the front wall;
a first curved side wall extending from the backside to the front wall; and
a second curved side wall extending from the backside to the front wall.

31. The method of claim 29, further comprising hollowing out the manifold body to define a manifold body internal cavity opening to the backside.

32. The method of claim 28, wherein providing the light guide panel includes forming a plurality of light turning features in an optically transmissive panel, the optically transmissive panel forming the light guide panel.

33. The method of claim 28, further comprising attaching a display under the light guide panel.

34. The method of claim 33, wherein the display includes a plurality of interferometric modulators, the interferometric modulators forming pixels of the display.
